(19) United States
(12) Patent Application Publication
(10) Pub. No.: US 2013/0066700 A1
(43) Pub. Date: Mar. 14, 2013

(54) GROUP TRANSACTION PROCESSING USING A SOCIAL STREAM

(71) Applicants: William L. Portnoy, Woodinville, WA (US); Lili Cheng, Bellevue, WA (US); Paul A. Steckler, Redmond, WA (US); David A. Raskino, Kirkland, WA (US); Matthew G. Dyor, Bellevue, WA (US)

(72) Inventors: William L. Portnoy, Woodinville, WA (US); Lili Cheng, Bellevue, WA (US); Paul A. Steckler, Redmond, WA (US); David A. Raskino, Kirkland, WA (US); Matthew G. Dyor, Bellevue, WA (US)

(73) Assignee: Microsoft Corporation, Redmond, WA (US)

(21) Appl. No.: 13/231,976

(22) Filed: Sep. 14, 2011

(51) Int. Cl. G06Q 30/00

(52) U.S. Cl. 705/14.23; 705/26.2; 705/14.66; 705/80

(57) ABSTRACT

A user provides an input to a public stream system indicating that the user desires to conduct a transaction (such as a sale, renting a piece of equipment, etc.). The system identifies a group of other users that may wish to participate in the transaction, and at some point, informs those users of the opportunity to participate in a group transaction. Offers for the group transaction are identified and made available to the users and user acceptance of, and commitment to, the offer is tracked. Incentives can optionally be provided to one or more members of the group.

### BACKGROUND

Current information retrieval systems allow users to employ search engines to search, through a variety of different corpora, either directly or over a network. For instance, some information retrieval search engines allow a user to submit a query to search for information over a wide area network. The search engine identifies results based on the query and returns a search engine results page to the user.

In some information retrieval systems, advertisements are displayed on the search engine results page, based on the particular results being provided by the search engine. For instance, if a user submits a query to buy a certain product (such as skis, for example), the search engine will likely return a list of ski manufacturers or ski sellers, and may display advertisements on the search engine results page related to skis or other skiing equipment. However, these conventional types of information retrieval systems are private, in that both the search query and the search engine results page are not displayed in a social context or displayed publicly to other users. Nor is the identity of any given user known to any other users of the information retrieval system.

A social network is a social structure made up of individuals or organizations referred to as nodes or users. The nodes or users are connected by one or more specific types of interdependency, such as friendship, kinship, common interest, related beliefs, or knowledge, to name a few. Social network sites are currently popular. Social network sites provide on-line services, platforms, or other site-specific functions, that focus on building social networks among users based on the social interdependency of those users. Many social network services are web-based and provide means for users to interact, over a wide area network.

Such social network sites provide computer-implemented social interaction by publishing posts from an individual user to a public stream that is distributed to other individuals connected, through interdependency, to the user that authored the post. The individuals that receive the public stream are all known to one another, and thus facilitates a social context among the various communications of the users.

The discussion above is merely provided for general background information and is not intended to be used as an aid in determining the scope of the claimed subject matter.

### SUMMARY

Conventional information retrieval systems are private and provide no social context. Therefore, even if a user of the information retrieval system is expressly searching to buy a product, there is no way of using a social context to motivate the purchase of a given product, nor is there any opportunity to leverage the social context of a social network to drive additional sales of that product.

In the present disclosure, a user provides an input to a public stream system indicating that the user desires to conduct a transaction (such as a sale, renting a piece of equipment, etc.). The system identifies a group of other users that may wish to participate in the transaction, and at some point, informs those users of the opportunity to participate in a group transaction. Offers for the group transaction are identified and made available to the users and user acceptance of, and commitment to, the offer is tracked. Incentives can optionally be provided to one or more members of the group.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of a public stream system connected to users and vendors.

FIG. 2 is a block diagram showing a group transaction processing system in more detail.

FIG. 3 is a flow diagram showing one embodiment of the overall operation of the system shown in FIGS. 1 and 2.

FIG. 4 is a flow diagram illustrating various embodiments for identifying a potential group for participation in a transaction.

FIG. 5 is a flow diagram illustrating various embodiments for identifying offers that can be taken advantage of by a group.

FIG. 6 is a flow diagram illustrating one embodiment of how vendors can initiate an offer.

FIG. 7 is a flow diagram illustrating one embodiment of how offers can be generated and provided to users.

FIG. 8 is a simplified block diagram of a public search system, in accordance with one embodiment.

FIG. 9 is a simplified flow diagram illustrating one embodiment of the operation of the system shown in FIG. 8.

FIGS. 10A-10C are exemplary embodiments of user interface displays.

FIG. 11A is a flow diagram showing one embodiment of processing click data.

FIGS. 11B and 12 show exemplary embodiments of user interface displays.

FIG. 13 is a more detailed block diagram of a public search system, in accordance with one embodiment.

FIG. 14 is a more detailed flow diagram illustrating one embodiment of the operation of the system shown in FIG. 13.

FIG. 15 is a flow diagram illustrating one embodiment for processing a query.

FIG. 15A illustrates one embodiment of information stored in a topic and statistics data store.

FIG. 15B illustrates one embodiment of information items contained in an exemplary record for a post

FIG. 16 is a more detailed flow diagram showing one embodiment for processing click data.

FIG. 17 is a simplified block diagram of an interest tracking component, in accordance with one embodiment.

FIG. 18 is a simplified flow diagram illustrating one embodiment of the operation of the interest tracking component shown in FIG. 17.

FIG. 19 illustrates one embodiment for processing a message input.

FIG. 20 is a block diagram of one illustrative computing environment in which the public search stream can be implemented.

### DETAILED DESCRIPTION

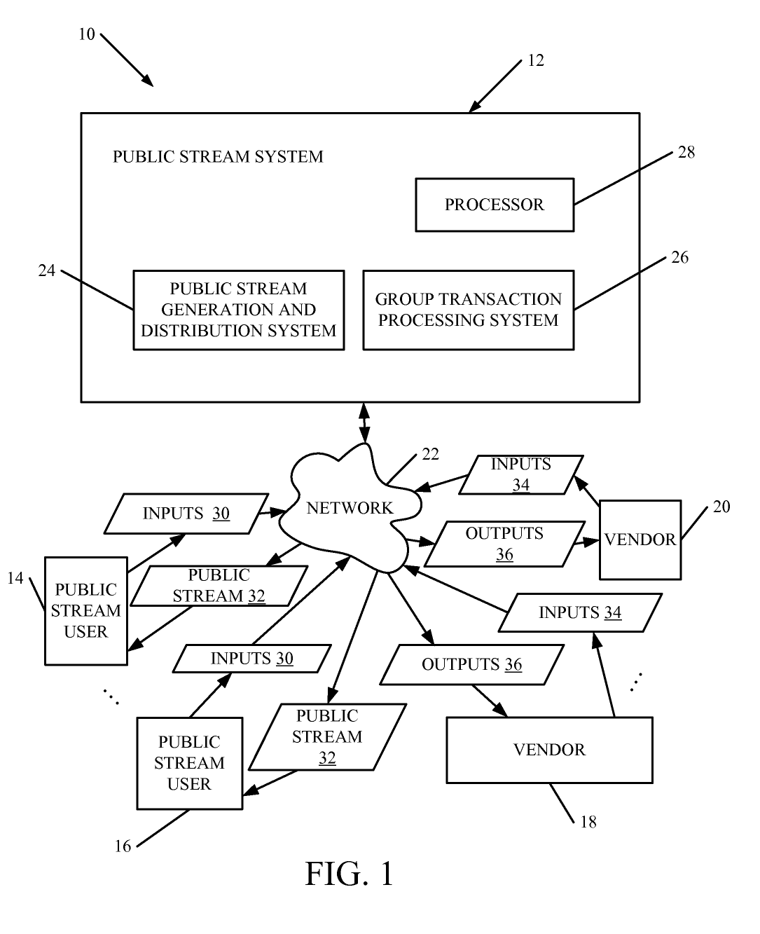

FIG. 1 is a block diagram of a social network 10 that employs a public stream system 12. Public stream system 12 is connected to a plurality of users 14-16, as well as to a plurality of different vendors 18-20 through network 22. The users 14-16 and vendors 18-20 illustratively form nodes in the social network 10. Public stream system 12 facilitates social network services and thus tracks the connection of the nodes of the social network, based on various types of interdependency.

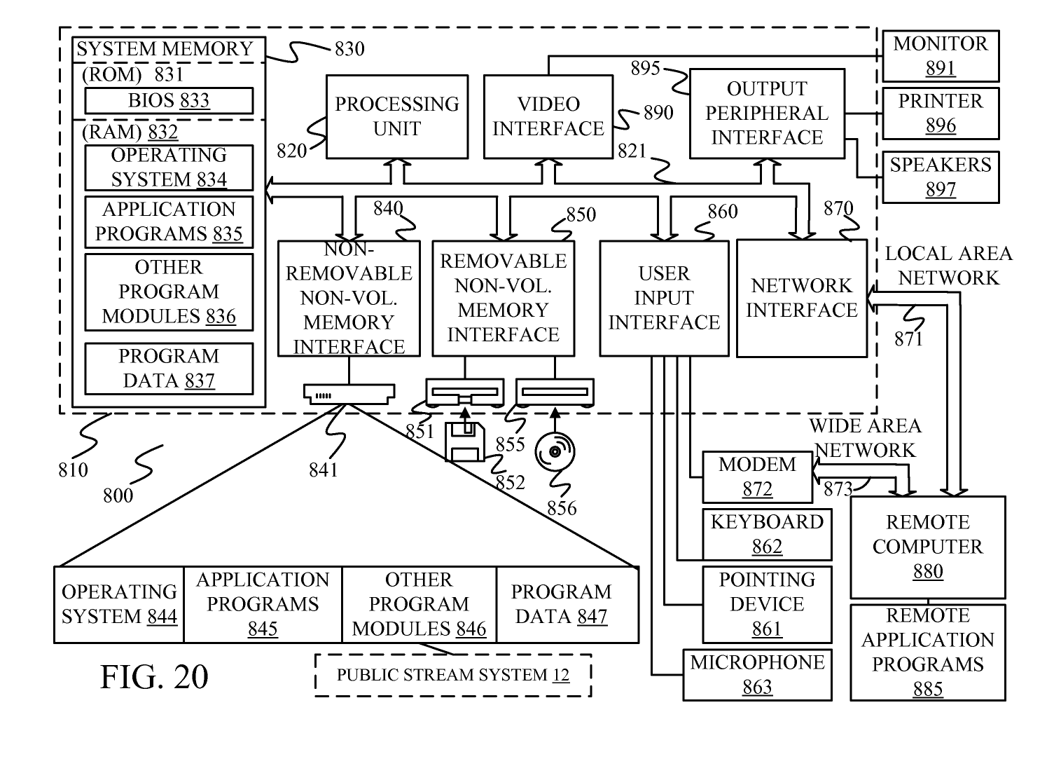

FIG. 1 shows that public stream system 12 illustratively includes public stream generation and distribution system 24, group transaction processing system 26 and processor 28. Processor 28 is illustratively a computer processor that includes memory and timing circuitry (not separately shown). Processor 28 is illustratively activated by the various components of system 12 and facilitates the functions performed by those components. A number of different embodiments of processor 28 are described below with respect to FIG. 20.

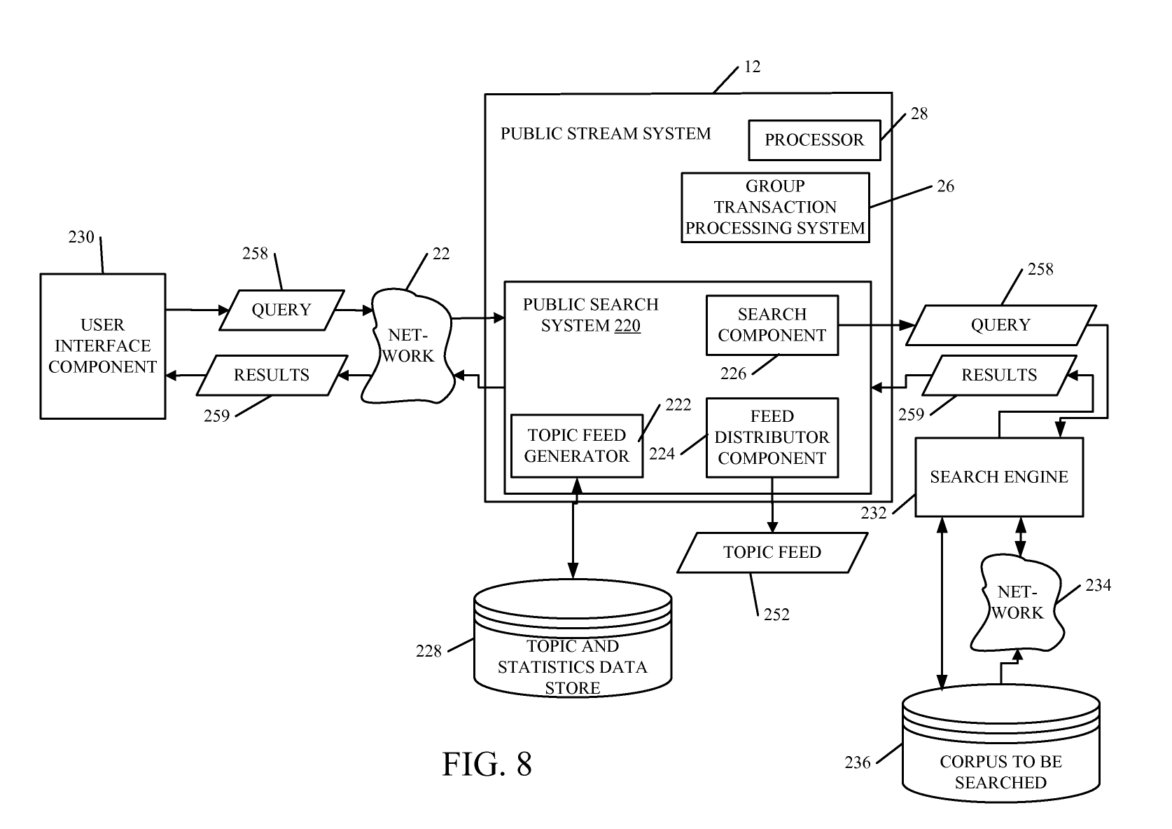

In one embodiment, public stream generation and distribution system 24 handles functions associated with maintaining a social graph that connects the users (or nodes) in the social network based on their interdependency, and also handles generating and distributing a public stream of information among the connected users, as well as explicitly and implicitly identifying the interests of those users. System 24 can optionally perform a wide variety of different functions as well. One embodiment of system 24 is an open, social search architecture which is described below in greater detail with respect to FIGS. 8-19.

Group transaction processing system 26 illustratively integrates the social aspects of the social network facilitated by system 24 into the purchasing (or other transaction conducting) process. For instance, users illustratively provide various types of inputs 30 to public stream system 12 (via network 22). Public stream generation and distribution system 24 generates and distributes public stream 32 to the various users based on the inputs 30 received from the users and based on functional processing performed by system 24 and system 26. Vendors 18-20 can also provide inputs 34 to, and receive outputs 36 from, system 12.

Group transaction processing system 26 also analyzes the input 30 from various users 14-16 to identify whether the user that provided the input 30 is potentially interested in conducting a business or financial transaction. Such transactions can include a decision by one user 14-16 to purchase an item, to rent or lease an item, or to otherwise engage in a business transaction. When group transaction processing system 26 identifies that a user is interested such a possible transaction, a variety of different things can happen in order to facilitate a group-buying transaction. These are described in greater detail below.

Briefly, however, for the sake of better understanding, assume that user 14 provided an input that indicates user 14 is interested in buying some product. System 26 can notify other users 16 that have shown interest in that product that user 14 is about to buy the product or is interested in buying the product. System 26 can offer the other users the opportunity to join a group in buying that same product. If the size of the group is large enough, system 26 can provide this information to relevant vendors 18-20 in the hopes of one of those vendors offering the group a discount or another incentive to buy the product. In another embodiment, system 26 can provide a user interface to user 14 to specify a group transaction that is offered to other users. If the other users join and commit to the transaction, then the group transaction can be provided to the vendors 18-20 for acceptance. Similarly, system 26 can provide an interface to vendors 18-20 which allows them to search for groups of users 14-16 that may be interested in purchasing their products, based upon the information in public stream 32. Then, a given vendor 18-20 can generate a targeted offer and provide it specifically to those users. Of course, system 26 can also illustratively search through a data store of pre-existing offers, based on information received in the public stream 32 or inputs 30 from users 14-16, and relevant pre-existing offers can be surfaced to a potential group of buyers. These and other group transaction scenarios are described below in greater detail.

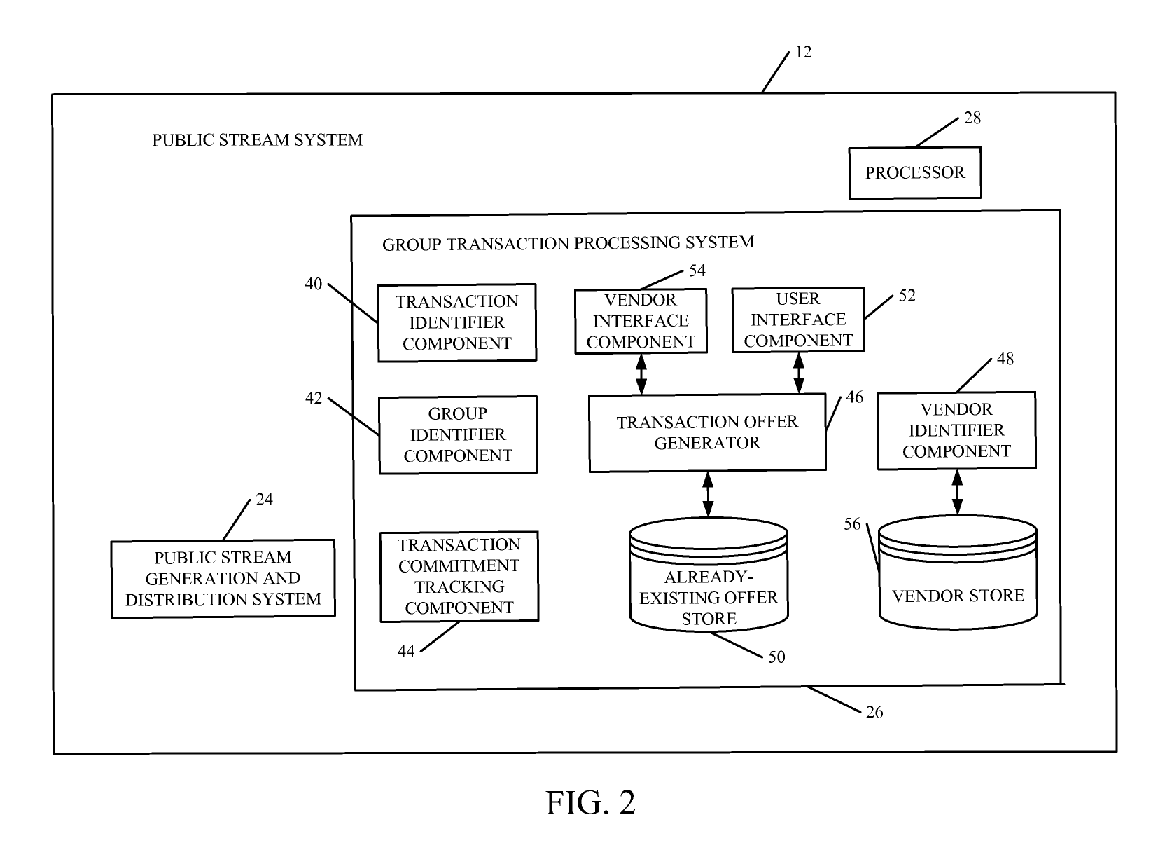

FIG. 2 is a block diagram of public stream system 12 showing group transaction processing system 26 in greater detail. In the embodiment shown in FIG. 2, system 26 illustratively includes transaction identifier component 40, group identifier component 42, transaction commitment and tracking component 44, transaction offer generator 46 and vendor identifier component 48. The embodiment in FIG. 2 shows that transaction offer generator 46 is coupled to an already-existing offer store 50 that stores preexisting or already-existing offers from a variety of vendors 18-20 (FIG. 1). FIG. 2 also shows that transaction offer generator 46 is illustratively coupled to user interface component 52 and vendor interface component 54. User interface component 52 illustratively generates user interface displays provided to users 14-16 so that the users can generate or interact with offers. Vendor interface component 54 illustratively generates user interface displays for vendors 18-20 that allows vendors to identify the opportunities for generating offers, or interact with offers.

FIG. 2 also shows that vendor identifier component 48 is illustratively coupled to vendor store 56 that is a corpus of information that identifies a variety of different vendors 18-20. Therefore, vendor identifier component 48 can identify relevant vendors that may wish to be notified of various trends or opportunities identified by group transaction processing system 26.

It will be noted, of course, that the components shown in FIG. 2 can be combined or they can be further divided into other components as well. The components illustrated are illustrated for exemplary purposes only. Also, of course, it will be noted that data stores 50 and 56 in FIG. 2 can be separate from system 12, but accessible by system 12, such as over a network or through a direct connection. Finally, it should be noted that components of systems 24 and 26 can be combined or the systems can be divided out in different ways, other than those shown in FIG. 2. The particular division of components shown in FIG. 2 is provided for the sake of example only.

Transaction identifier component 40 illustratively analyzes the various inputs 30 and public streams 32 received from, and provided to, users 14-16 and identifies possible transactions that the users 14-16 have shown interest in. Group identifier component 42 illustratively examines inputs 30 and public stream 32 to identify a potential group of users 14-16 that may wish to engage in the transaction as well. Transaction offer generator 46 illustratively provides user interfaces 52 and 54 to allow either a user or a vendor to generate offers to the group identified by group identifier component 42, or to surface already-existing offers from store 50 for presentation to the potential group identified by group identifier component 42. Vendor identifier component 48 illustratively identifies relevant vendors for any transaction identified by component 40 and notifies those vendors. Transaction commitment tracking component 44 then tracks the commitment by the various users in the potential group that have accepted an offer. For instance, component 44 tracks whether a user has accepted the offer and then executed on the offer (such as purchased a given product that is the subject of the offer, etc.).

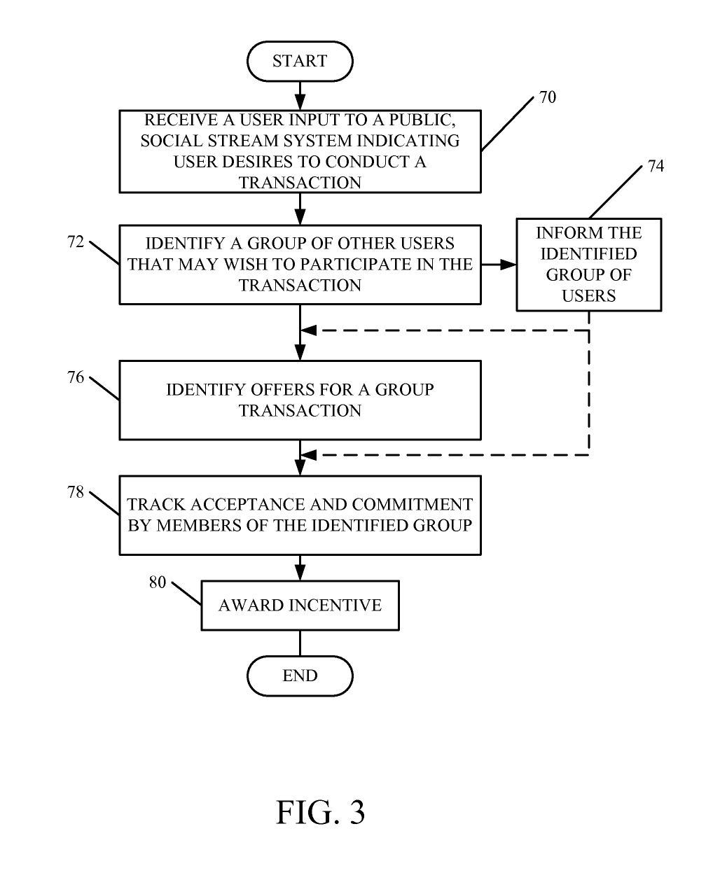

FIG. 3 is a flow diagram illustrating one embodiment of the overall operation of public stream system 12 in facilitating a group-based transaction. First, public stream system 12 receives a user input 30 from a user (such as user 14) indicating that the user desires to conduct some type of transaction. While the transaction can be any type of transaction that may benefit by having a group involved the present discussion will proceed, for the sake of example, with respect to a transaction where user 14 has indicated a desire to purchase skis. Receiving this type of input 30 from user 14 is indicated by block 70 in FIG. 3.

When this input is received, transaction identifier component 40 illustratively analyzes the input and identifies that the user desires to conduct a transaction. For instance, component 40 may include a natural language processing system (or it may be included elsewhere in the system) that analyzes the linguistic content of an input 30 to identify that the user does wish to purchase skis. Alternatively, of course, the user may have actuated a “buy” button or otherwise directly entered contextual information in the input 30 indicating that the user wishes to purchase skis. Similarly, the user may simply click on a link that navigates the user to a vendor 18-20 who is a manufacturer or seller of skis. In addition, and as is described below with respect to FIGS. 8-19, public stream system 12 can be a public search system in which the user can enter input 30 as a search query or information retrieval query indicating that the user wishes to receive information about purchasing skis. For example, the user may have entered a query “where can I buy skis at a discount?” In any case, transaction identifier component 40 identifies that the user 14 has indicated a desire to conduct a transaction. That transaction, in this example, is that the user 14 wishes to purchase skis.

Group identifier component 42 then identifies a potential group of other users who may wish to participate in the transaction. This can be done in a wide variety of different ways, and various embodiments are discussed below with respect to the remaining figures. However, in one embodiment, public stream generation and distribution system 24 tracks the interests of the various users 14-16 of system 12. Therefore, once transaction identifier component 40 identifies that user 14 wishes to purchase skis, group identifier component 42 can identify other users 16, that are socially connected to user 14 and that are also interested in the topic or subject matter area of skis or skiing, as a potential group. Identifier component 42 can identify a potential group for participation in the transaction initiated by user 14 in other ways as well. For instance, where system 12 is a public search system, then the query input by user 14 is illustratively a public query that is distributed in public stream 32. If any of the other users 16 interact with that query or the results returned based on that query in public stream 32, then group identifier component 42 can identify those users as members of the potential group as well.

In addition, in one embodiment, the extent to which group identifier component 42 searches for members of a group can be controlled. Component 42 may be limited (through appropriate parameters input by user 14, for instance) to looking for group members only among a small subgroup of users, such as the followers or friends of user 14. Similarly, in one embodiment, user 14 can specify that component 42 is to omit a certain user (or users) from the group. By way of example, user 14 may publish a group purchase offer fro a birthday gift to all friends except the intended recipient. Of course, other limitations on the potential group members can be used as well.

Other ways of identifying potential group members are discussed below, and identifying a group of users that may wish to participate in the transaction is indicated by block 72 in FIG. 3.

The identified users (members of the group) are then, at some point, notified that they are potential members of the group and they are offered the opportunity to join in the group transaction. This is indicated by block 74 in FIG. 3 and can be done in a variety of different ways. For instance, system 26 may wait until the potential members of the group have, themselves, provided an input 30 indicating that they are interested in joining such a transaction. That is, continuing with the same example, system 26 may wait until a user 16 has, himself or herself, input a search query indicating that that user 16 wishes to purchase skis. In that case, user 16 can be notified that user 14 is also interested in purchasing skis and user 16 can be offered the opportunity to join a group for the purposes of obtaining a discount on the purchase of a certain type of skis. Alternatively, where user 14 desires to actively solicit members of a group to purchase skis, transaction offer generator 46 can allow user 14 to specify that by generating a post through a user interface generated by user interface component 52. The post is then displayed on the public stream 32 distributed to user 16. In this way, user 16 is automatically notified that a group is being formed for purchasing skis. This can be done even before user 16 submits a query looking for skis.

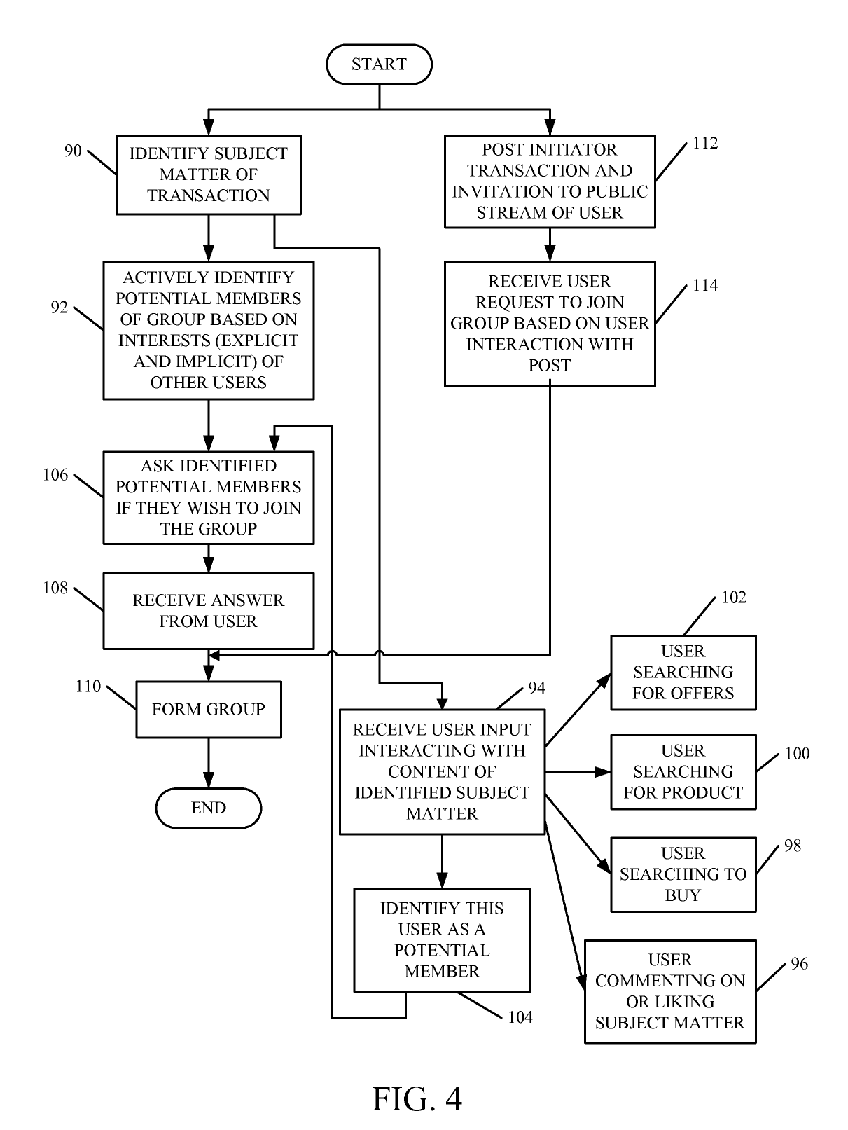

In any case, once a potential group is formed, transaction offer generator 46 illustratively identifies an offer for the group transaction. This is indicated by block 76 in FIG. 3. Offers can also be generated in a variety of different ways and some of them are described below with respect to FIGS. 4-7. For the sake of example, however, generator 46 can allow user 14 (or another user) to set the terms of an offer through user interface component 52. Similarly, once the group is formed, transaction offer generator 46 can provide a vendor interface through vendor interface component 54 that allows a vendor to directly submit a group purchasing offer to the group that has been formed. Where certain, indentified vendors are to actively participate in generating new offers (or in responding to offers generated by a user) vendor identifier component 48 illustratively searches vendor store 56 to identify those relevant vendors (such as ski manufacturers or sellers). The relevant vendors can then generate or respond to offers directly. In yet another embodiment, transaction offer generator 46 simply searches already-existing offer store 50 to find relevant pre-existing offers which can be surfaced for users that are part of the potential group. Other ways of identifying offers for the group transaction can be used as well.

Once the group has been formed, relevant vendors have been identified and relevant offers have been either generated or preexisting offers have been identified, the offers are presented to the members of the group and transaction commitment tracking component 44 then tracks which users in the group accept the offer and which of them actually follow through (or commit to) the offer by conducting the transaction (e.g., by purchasing skis according to the terms of the offer). This is indicated by block 78 in FIG. 3.

Then, it may happen that some offers have associated incentives. For instance, if user 14 initiates an offer, by communicating through public stream 32 that he or she is about to purchase skis from a given vendor 18-20 that vendor may provide incentive to user 14 such as providing a 10% discount for every additional user 16 that purchases skis under the terms of that offer. Transaction commitment tracking component 44 tracks this information as well and awards incentives, as indicated by block 80 in FIG. 3.

FIG. 4 is a flow diagram illustrating, in more detail, a variety of different embodiments by which group identifier component 42 identifies a potential group of users that may wish to join in a transaction identified by component 40. This corresponds to block 72 in FIG. 3 and shows that process in greater detail. In one embodiment, transaction identifier component 40 illustratively identifies the subject matter of the transaction requested by user 14. This can be done in a wide variety of different ways. For instance, where the user 14 interacts with an item in public stream 42, the subject matter of that item will be the subject matter of the transaction. Similarly, if the user inputs a search request indicating the user wishes to engage in a transaction, then the subject matter of the search request is the subject matter of the transaction. This can be done using natural language processing, by keyword matching, using statistical or rules-based models, etc. Identifying the subject matter of the transaction is indicated by block 90 in FIG. 4. In any case, the user's input 30 is illustratively incorporated into public stream 32 and provided to other users 16 of system 12 as a post in public stream 32.

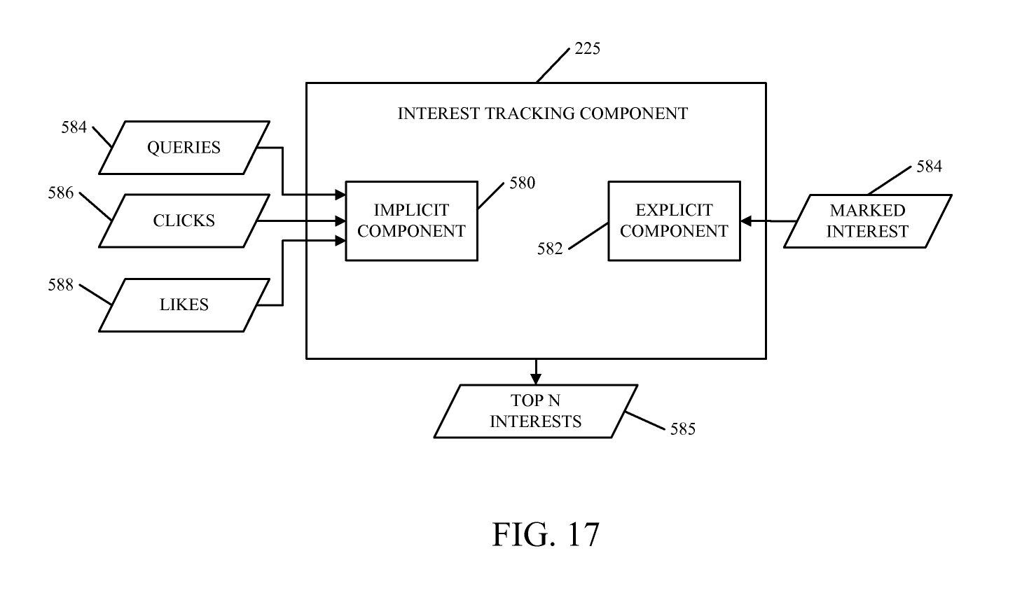

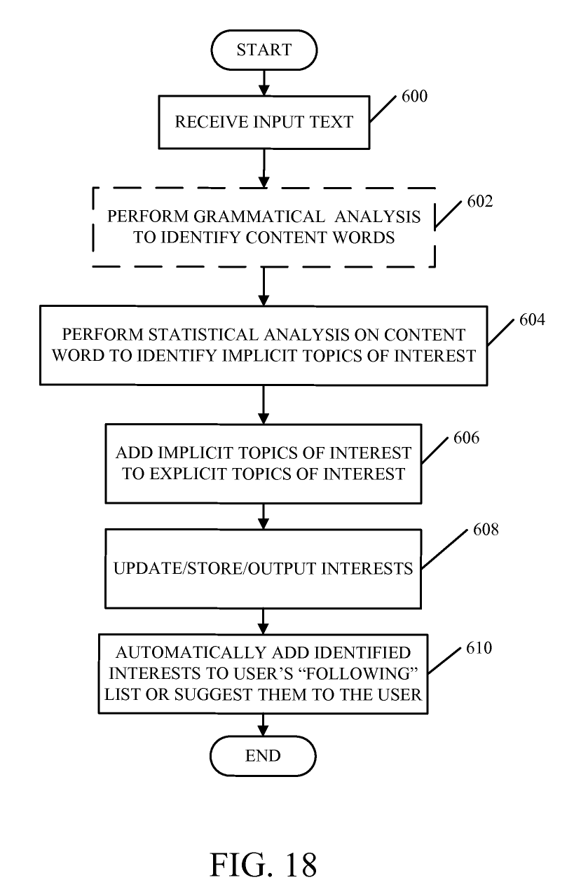

Once this is done, group identifier component 42 can react in a number of different ways. For instance, component 42 can actively identify potential members of a group based on the interests of the other users 16 of system 12 (whether those interests are explicitly indicated or implicitly identified as described below with respect to FIG. 17-18). This is indicated by block 92 in FIG. 4. For example, assuming that the subject matter of the transaction is the purchase of skis, public stream generation and distribution system 24 illustratively tracks all users that are interested in skis. Therefore, group identifier component 42 requests system 24 to identify those users so that the offer can be provided to them, and so they can be given an opportunity to join in the group.

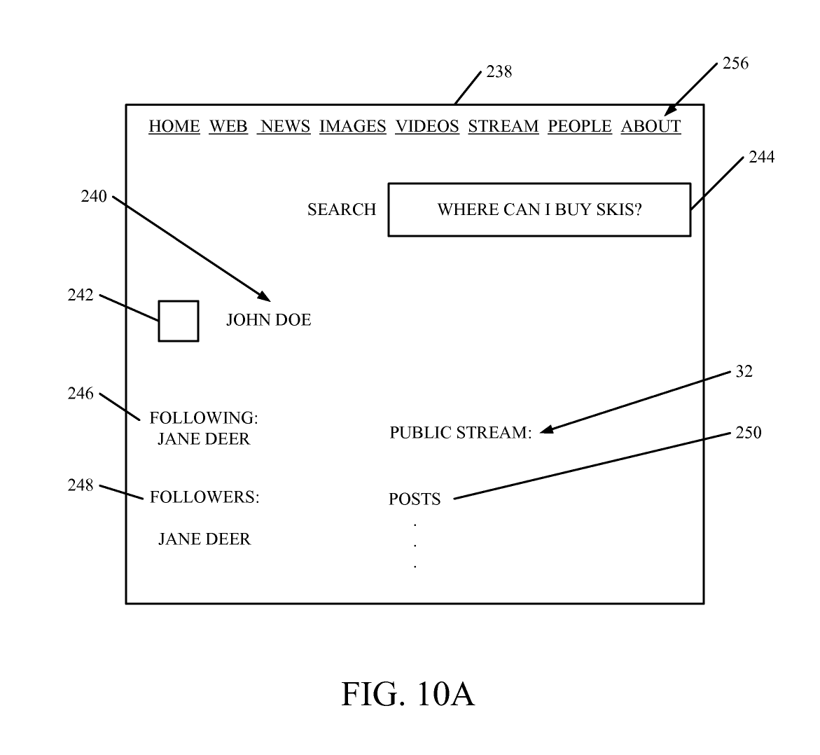

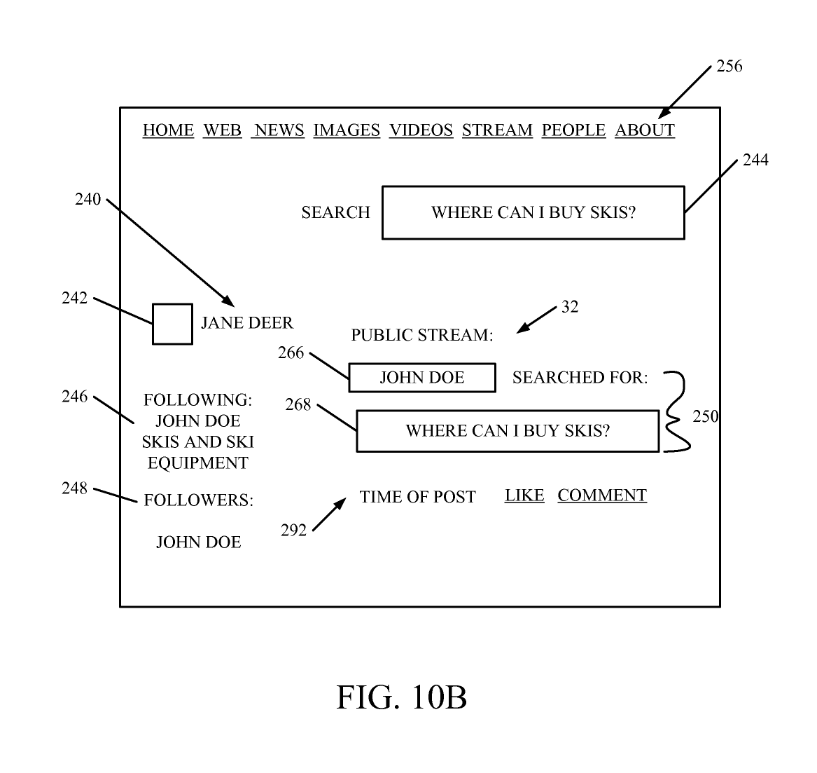

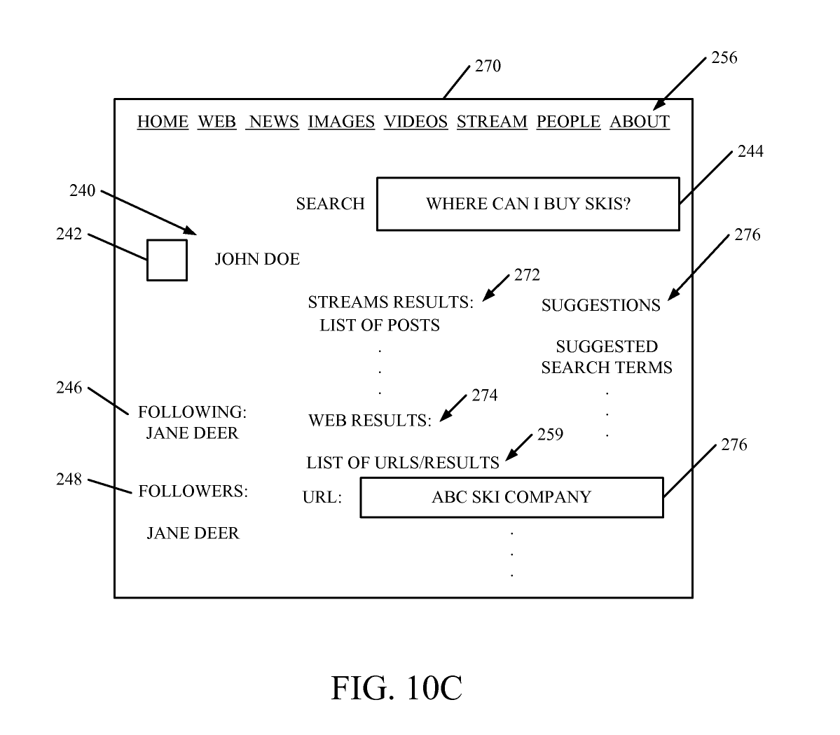

In an alternative embodiment, once the subject matter of the transaction is identified, then once the input corresponding to the transaction has been published in the public stream 32 for other users, group identifier component 42 can simply wait to receive from another user 16 an input interacting with the content of the identified subject matter. This is indicated by block 94 in FIG. 4. For instance, if the input by user 14 identifying the transaction is an information retrieval query such as “where can I buy skis?” then that, along with the results returned in response to the that query are published by system 24 in public stream 32 to various users. Group identifier component 42, instead of actively identifying users who are interested in skis, can simply wait to receive an input 30 from a user interacting with the content of the post in the public stream that is related to the transaction. That is, a user 16 may click on one of the links returned in response to the query of user 14, or may “Like” one of the search results or the search itself, or otherwise “Comment” on the post in the public stream 32 that represents the transaction. This type of interaction by user 16 is indicated by block 96 in FIG. 4, and is described in more detail with respect to FIGS. 10A-10C.

Similarly, instead of actively identifying group members, component 42 may wait until another user 16 has, himself or herself, input a query similar to that input by user 14 indicating that user 16 also wishes to purchase skis. This is indicated by block 98.

Other interactions include user 16 simply conducting a general search for information about the subject matter (such as a search for general information about skis). This is indicated by block 100 in FIG. 4. Or the user may specifically input a query looking for offers related to group purchasing of skis at discount. This is indicated by block 102. That is, the user may be actively attempting to identify other groups that already exist, and that wish to purchase skis. If the user inputs this type of search input, then group identifier component 42 illustratively identifies that user 16 as a potential member of the group.

All of these ways of identifying potential group members (those shown at blocks 96-102 in FIG. 4) do not involve group identifier component 42 actively interacting with system 24 to identify users that may be members of the group, but instead involve component 42 simply waiting for other users to show interest in joining such a group. In any case, if the user takes any of these actions, then group identifier component 42 identifies that user as a potential member of the group. This is indicated by block 104 in FIG. 4.

Once component 42 has identified potential members of the group (as indicated above with respect to blocks 92 or 104) then group identifier component 42 illustratively notifies those identified users of this, and asks them if they wish to join the group. This is indicated by block 106 in FIG. 4 and this can be done in a number of different ways as well. For instance, once a user 16 has been identified as a potential member of the group, a special notification can be generated for that user 16 and provided, separate from public stream 32, to user 16. Alternatively, component 42 can simply generate a post in public stream 32 (using system 24) indicating that the user 16 is a potential member of a group transaction, and the post can also ask the user whether he or she wishes to join the group. Other ways of notifying the user that they are a potential member of the group, and asking them whether they wish to join the group, can be used as well.

In any case, group identifier component 42 illustratively receives answers from various users indicating that they do, or do not, wish to be members of the group. This is indicated by block 108. Based on those responses, the group is formed as indicated by block 110.

FIG. 4 illustrates one other embodiment of the operation of group identifier component 42 in identifying potential group members and forming a group. In that embodiment, the user 14 that is initiating the transaction can be provided a user interface display, from transaction offer generator 46 and through user interface component 52, that allows user 14 to actually configure the terms of a desired offer and present that to other users. For instance, user 14 may generate a message such as “I am about to purchase skis from ABC Ski Company. If we can get 15 people to buy skis, they will give us a 10 percent discount on all purchases. Do you wish to join a group purchase of skis from ABC Company?” This message can be incorporated into the public stream 32 of the friends of user 14 along with actuable links that allow the other users 16 to opt in or opt out of the group. Posting the transaction and invitation to the public stream of other users 16 is indicated by block 112 in FIG. 4.

The other users 16 can then either join the group, abstain from joining or explicitly indicate that they will not be joining This can be done through interacting with the post in their public stream 32. Receiving the user request to join the group or abstain or not join the group based on their interaction with the post is indicated by block 114 in FIG. 4.

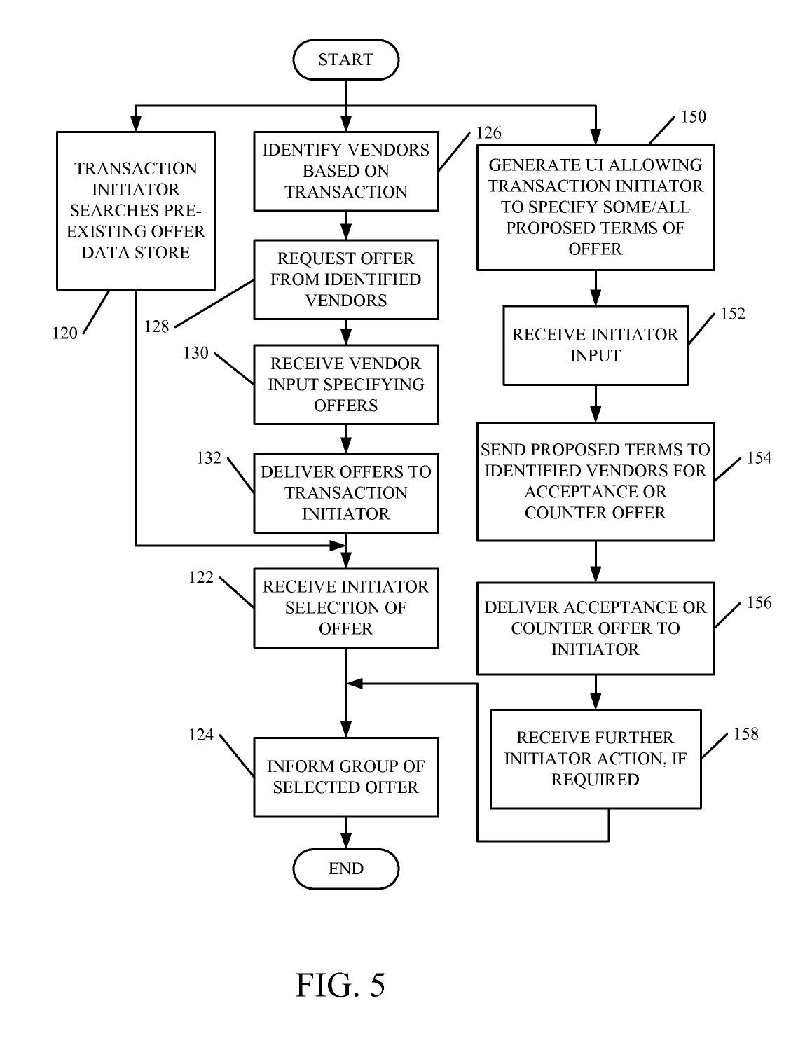

FIG. 5 is a flow diagram illustrating various embodiments of the operation of transaction offer generator 46 in identifying or generating offers once the subject matter of a transaction initiated by user 14 has been identified. In one embodiment, transaction offer generator 46 receives the subject matter of the transaction that has been initiated, from component 40, and also optionally receives the identity of group members from component 42. Generator 46 can then search the already-existing offer store 50 for pre-existing offers that relate to the subject matter of the transaction and present them to member of the group, through user interface component 52, as a post in the public stream 32 of the members of the group. Additionally, the offer can be presented as a separate notification, or as a separate message outside the public stream 32, to the members of the group, or it can be presented in other ways as well. In addition, in one embodiment, the user 14 that is initiating the transaction may be provided with a search user interface through user interface component 52 that allows user 14 to, himself or herself, search through already-existing offer store 50 for offers he or she may wish to take advantage of. In either case, searching already-existing offer store 50 for preexisting offers and presenting any relevant preexisting offers to the initiator 14 of the transaction is indicated by block 120 in FIG. 5.

Once the relevant offers have been presented to the initiator 14 of the transaction, the initiator can select one of the offers for propagation to the group. For instance, it may be that multiple vendors 18-20 are providing discounts on ski equipment. Initiator 14 may choose the best offer for propagating to the identified group. Receiving the initiator selection of an offer is indicated by block 122 in FIG. 5. Then, the members of the group are informed in one of the various ways already discussed. This is indicated by block 124 in FIG. 5.

FIG. 5 also shows that transaction offer generator 46 can operate in a different way to generate offers. For instance, once transaction identifier component 40 has identified the subject matter of the transaction (e.g., that user 14 wishes to purchase skis), a transaction offer generator 46 can obtain from vendor identifier component 48 the identity of relevant vendors (such as ski manufacturers and sellers). Component 48 can identify these vendors in a number of different ways. For instance, component 48 can match keywords corresponding to the identified transaction with keywords corresponding to various vendors 18-20 stored in vendor store 56. Alternatively, component 48 can do more complex natural language processing or statistical matching of the subject matter of the transaction to subject matter corresponding to the vendors. In any case, identifying relevant vendors based on the subject matter of the transaction is indicated by block 126 in FIG. 5.

Transaction offer generator 46 can then notify the identified vendors 18-20 through vendor interface component 54, that a user 14 is interested in conducting a transaction. Transaction offer generator 46 can also solicit offers from the identified vendors. That is, generator 46 can request the vendors to submit offers that will be relayed directly to the initiator of the transaction (e.g., user 14). Requesting an offer from the identified vendors is indicated by block 128 in FIG. 5.

The identified vendors 18-20 are illustratively provided with a vendor interface display through vendor interface component 54 that allows them to configure an offer, as they desire. For instance, a vendor may configure an offer such that if 10 people buy skis, they will all get a 20% discount. Alternatively, the vendor may configure the offer such that, if 10 people buy skis within the next two days, then the initiator (user 14) will get 10% off for each additional pair of skis purchased by the group. Of course, any other desired offer can be configured by the vendor and submitted through transaction offer generator 46. This is indicated by block 130 in FIG. 5. The various offers submitted by various vendors 18-20 are then passed along to the initiator (e.g., user 14) of the transaction. This is indicated by block 132 in FIG. 5. The initiator can then select one of those offers to be submitted as a post in public stream 32 or to otherwise be submitted to the group of users. This is indicated by blocks 122 and 124 in FIG. 5.

FIG. 5 shows yet another embodiment in which the initiator of the offer (e.g., user 14) is allowed to specify the terms of the offer and submit it to vendors 18-20 to see if any of them will make the offer. In one embodiment, transaction offer generator 46 displays a user interface display, through user interface component 52, to user 14 (the initiator of the offer) which has user actuable elements (such as dropdown menus, text boxes, buttons, etc.) that receive user inputs allowing the user to specify some or all of the proposed terms of an offer. This is indicated by block 150 in FIG. 5.

The initiator (e.g., user 14) then provides user inputs specifying the offer. For example, user 14 might specify that the offer is for a group to buy skis. User 14 may configure a proposed offer such that if five or more people buy skis from a given vendor, then the vendor will grant each of them a 10 percent rebate or 10 percent discount, etc. Receiving the initiator input specifying the terms of the proposed offer is indicated by block 152 in FIG. 5.

Transaction offer generator 46 then illustratively sends the proposed terms of the offer to identified vendors for acceptance or for a counter offer. For example, transaction offer generator 46 can generate a vendor interface using vendor interface component 54 that alerts a relevant vendor to the fact that a user has proposed terms for a group offer. The vendor interface may, for example, allow all the relevant vendors to accept or reject the offer, or to make a counter offer. Sending the proposed terms to the identified vendors is indicated by block 154 in FIG. 5.

Once the identified vendors have interacted with the proposed terms of the offer, it is returned to the initiator. For instance, where a proposed vendor accepts the offer, the initiator (e.g., user 14) is then provided with a user interface display through user interface component 52 that indicates that a specific vendor has accepted the proposed offer sent by the initiator. Similarly, if the vendor rejects the offer, this can also be displayed to the initiator, and finally, if the identified vendor has generated a counter offer, this will be displayed to the initiator as well. By way of example, a vendor may counter offer by saying that, instead of offering a discount of 10 percent for a group of five purchasers, the vendor may offer a discount of 10 percent for a group of 10 purchasers. In any case, the offer acceptance, rejection, or counter offer, is provided to the initiator through an appropriate user interface display. Where the display indicates that the vendor has generated a counter offer, it also illustratively generates user interface elements (text boxes, buttons, dropdown menus, etc.) that allow the initiator to accept the offer, reject it, to generate a counter offer, or to engage in some other type of negotiation with the identified vendor. Delivering the vendors response to the initiator is indicated by block 156 in FIG. 5 and receiving any further initiator action, through the user interface (such as acceptance, a counter offer or other negotiation) is indicated by block 158 in FIG. 5.

In any of the embodiments in FIG. 5 (whether the offer is a pre-existing offer, whether the offer has been initiated by the vendor, or whether the offer has been initiated by the transaction initiator) once the offer has been accepted by both the initiator and a vendor, the group of possible participants in the transaction is informed of the offer, as indicated by block 124.

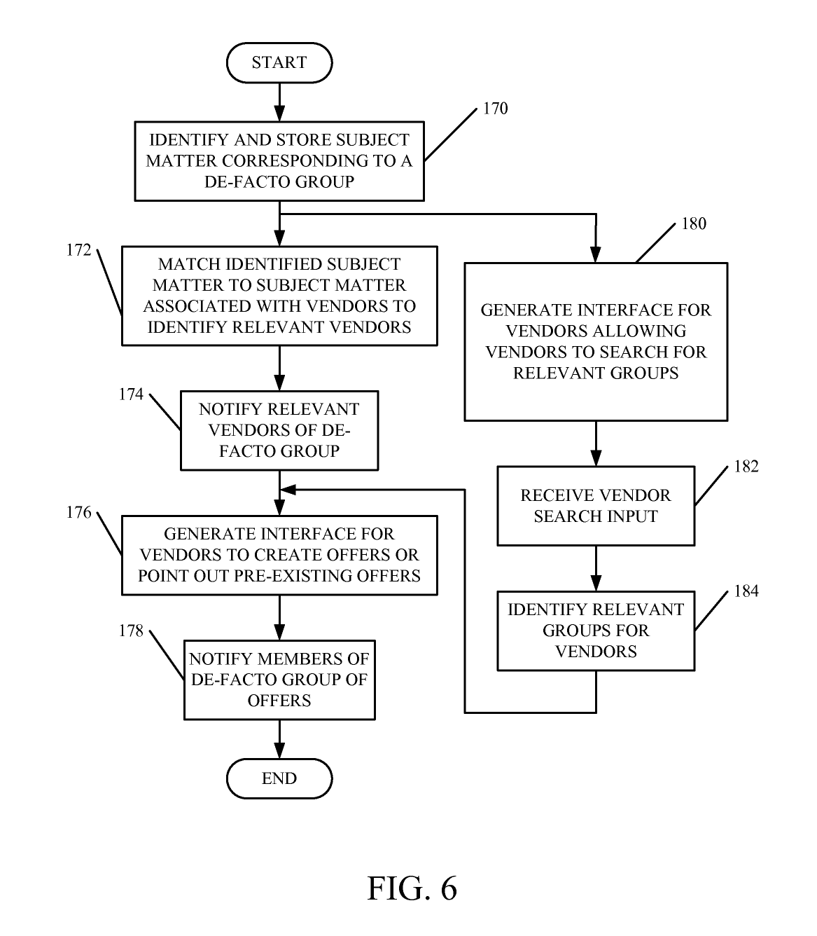

FIG. 6 is a flow diagram illustrating another embodiment in which a vendor takes action to initiate an offer, regardless of whether any user has attempted to initiate any type of offer. For example, it may be that a relatively large number of people using public stream system 12 are expressing interest in buying skis. However, it may also be that none of those users have taken any action to identify a group of users for a group-based transaction. This does not preclude one of vendors 18-20 from proactively generating an offer, based upon the interest of users 14-16, and prorogating that offer to the relevant group of users 14-16.

In one embodiment, transaction offer generator 46 provides, through vendor interface component 54, a user interface mechanism by which any of the vendors 18-20 can conduct searches of data collected by system 12 to identify potential groups of users that may be interested in a group transaction. In accordance with one embodiment, public stream generator and distribution system 24 identifies and stores the subject matter corresponding to the subject matter being searched, or otherwise interacted with, by users 14-16. System 24 illustratively maintains statistics indicating the number of users, and the identity of those users, that have interacted with content in their public stream 32, or provided inputs 30, corresponding to each of a variety of different topics or subject matter areas. This is described in greater detail with respect to FIGS. 8-19.

When a sufficient number of users have shown interest in a topic or subject matter area (by interacting with content related to that topic or subject matter area or by providing inputs related to it) then system 24 illustratively provides group identifier component 42 with an indication that a new, de-facto, group has been formed. System 24 also illustratively provides component 42 with a topic or subject matter area corresponding to the de-facto group that has been formed. Identifying and storing the subject matter corresponding to a de-facto group is indicated by block 170 in FIG. 6. As described above, the subject matter of the content interacted with by a user can be obtained in a variety of ways, including natural language processing analysis, keyword matching, or other ways.

Once this information (the subject matter and identity of a group) has been stored by system 12, transaction processing system 26 can react in a number of different ways. In one embodiment, vendor identifier component 48 matches the identified subject matter for the de-facto group to subject matter associated with vendors 18-20 (and illustratively stored in vendor store 56) to identify vendors that are relevant to the de-facto group. This is indicated by block 172 in FIG. 6. Again, this type of matching can be done using various kinds of linguistic processing including natural language processing, keyword matching, etc.

Once the relevant vendors are identified (relative to the de-facto group) those relevant vendors are notified that a de-facto group has been formed on system 12 in the subject matter area corresponding to the vendor. This is indicated by block 174 in FIG. 6. In one embodiment this can be done by simply sending a notification to the relevant vendors, or by notifying them in other ways.

Once the vendors have been notified, transaction offer generator 46 illustratively generates an interface through vendor interface component 54 that allows the relevant vendors to create offers or to identify pre-existing offers that can be made to the de-facto group. This is indicated by block 176. As discussed above with respect to FIG. 5, the user interface can provide user actuable elements that allow the vendors to input information that specify the terms of an offer. Transaction offer generator 46 then notifies the members of the de-facto group of any offers that have been created by relevant vendors. This is indicated by block 178. Again, notifying users of an offer can be done through system 12 in a variety of different ways, such as those discussed above with respect to FIGS. 3-5.

It can be seen that blocks 172-176 offer a push-type of model for notifying vendors that the de-facto group has been formed. That is, system 12 not only collects the information and identifies de-facto groups from the selected information, but it actively notifies vendors 18-20 that a group has been formed in their subject matter area.

However, after identifying that a de-facto group has been formed at block 170, system 26 can react in a different way as well. For instance, transaction offer generator 46 can simply provide vendors 18-20, through vendor interface component 54, the opportunity to search the information stored in system 12 to identify possibly relevant groups for the particular vendor. This is indicated by block 180 in FIG. 6. That is, when a vendor desires to make a group-based offer, the vendor may be provided with a search vendor interface that allows the vendor to search the statistics stored by system 24 to identify whether a large enough number of users 14-16 have shown sufficient interest in products corresponding to that vendor, that a group offer may be appropriate. In doing so, transaction offer generator 46 may illustratively receive a vendor search input looking for the appropriate information. This can be provided to group identifier component 42 which uses the search input from the vendor to identify whether any de-facto groups have been formed in the corresponding subject matter area. Group identifier component 42 can match the search input by the user to the subject matter areas for which de-facto groups have been identified using a variety of different techniques, including natural language processing, keyword matching, or other linguistic processing. Identifying the relevant groups for the vendors, based on the search input, is indicated by block 184 in FIG. 6.

After the groups have been identified to the vendors, then the vendors can generate an appropriate offer and that will be provided to members of the de-facto group as an opportunity to join in a group transaction. This is indicated by blocks 176 and 178 in FIG. 6. It can thus be seen that blocks 180-184 provide a pull-type model which allows the vendors to pull the relevant information from system 12 that a de-facto group has been informed. Of course, other mechanisms for vendor-initiated offers can be used as well.

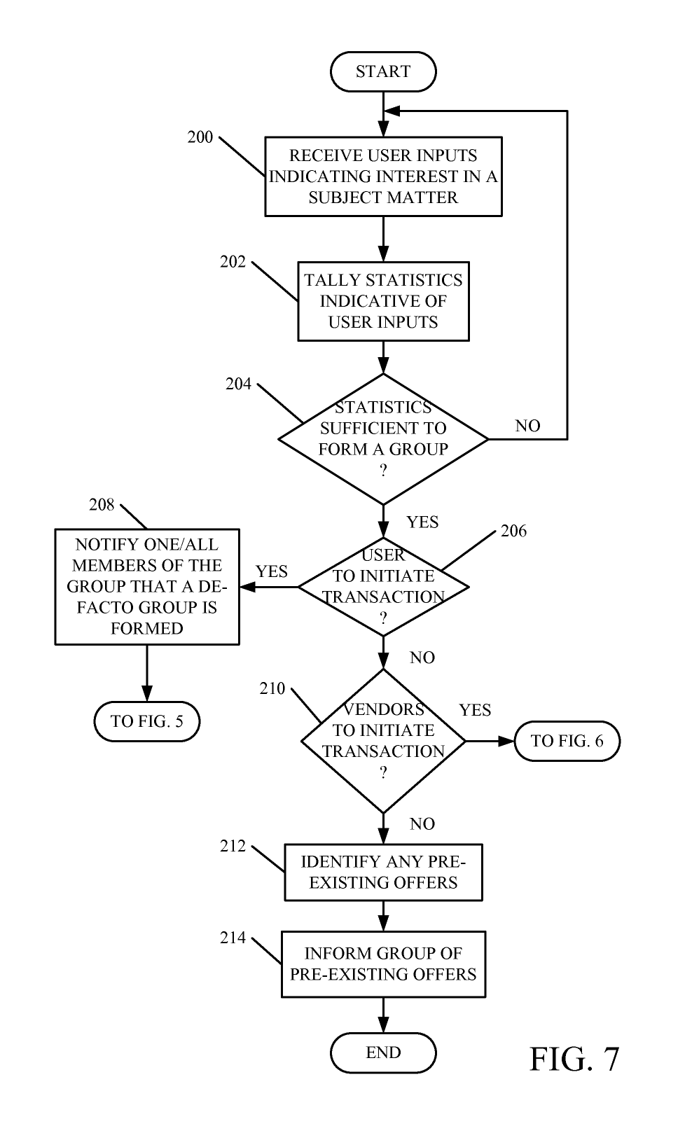

FIG. 7 is a flow diagram illustrating one embodiment of the operation of system 12 in identifying a de-facto group and then providing opportunities to the users or vendors to initiate an offer. In one embodiment, system 12 receives user inputs indicating that the users are interested in a given subject matter. This is indicated by block 200 in FIG. 7. System 24 then tallies the statistics that are indicative of those user inputs and that are thus indicative of a number of users that have shown interest in a given subject matter. This is indicated by block 202 in FIG. 7.

Group identifier component 42 is illustratively notified of these statistics, or periodically accesses them, and determines whether the statistics are sufficient to form a de-facto group out of the users that have shown interest in any of a plurality of different subject matter areas. This is indicated by block 204. This can be done in a variety of different ways. For instance, group identifier component 42 can have a threshold level of interest corresponding to a threshold number of users that have shown interest in a given subject matter area. When the number of users meets that threshold, then a de-facto group is formed. Other methods can be used as well. For instance, the threshold may differ based on the subject matter area, or the threshold may be specified by different vendors even within a given subject matter area. Therefore, the threshold for forming a de-facto group may vary based on subject matter area, based on vendor, or otherwise.

If the statistics are insufficient to form a de-facto group, processing returns to block 200. However, if at block 204, the statistics are sufficient to form a de-facto group then transaction offer generator 46 determines whether users have indicated interest in initiating transactions when a de-facto group has been formed. This is indicated by block 206 in FIG. 7. For instance, a user can illustratively set authentication and profile settings on system 12. In that way, the user can specify whether the user wants to be notified when a de-facto group has been formed in any of the subject matter areas of interest to that user. When that happens, processing at block 206 can proceed at block 208, where transaction offer generator 46 notifies one or all of the members of the de-facto group that a de-facto group has in fact been informed in the given subject matter area. In that case, transaction offer generator 46 can revert to processing as shown in FIG. 5, in which the offers can be generated in a variety of different ways.

If system 12 determines that it is not to provide user initiated transactions at block 206, then it determines whether any vendors have requested to initiate transactions. This is indicated by block 210 in FIG. 7. By way of example, vendors may register with system 12 and, in their profile or settable configuration settings, indicate that they wish to be notified when a de-facto group has been identified. If any vendors do wish to be notified, then processing continues as in FIG. 6 and the vendors can initiate a given offer.

If neither the users are to initiate offers, nor the vendors are to initiate offers, then transaction offer generator 46 can simply search through already-existing offer store 50 for already-existing offers that may be interest to the de-facto group. A group can be informed of those pre-existing offers as well. This is indicated by blocks 212 and 214 in FIG. 7. Of course, it should be noted that system 10 can proceed with processing along all of blocks 208, FIG. 5, FIG. 6 and blocks 212-214 simultaneously, or in succession. This is shown as alternative processing steps for the sake of example and explanation only.

It should also be noted that the flow of offers to any given users can be managed as well. For example, it may be that a given user does not wish to have all offers that are generated by vendors displayed separately in the public stream 32, or otherwise. This may clutter the pubic stream 32 of the user. Instead, a user may wish to have the offers rolled up into summary form, with links to the specific content of any given offer. In this way, when the user desires to view offers, the user can view the summary form of all outstanding offers and navigate to any particular offer of interest. The system can provide a user interface to allow a user to specify how offers are to be presented to that particular user. By way of example, it may be that a user only wishes to view offers that are presented by the user's close friends. It may also be that, when a user is actually searching for offers, they want to see all outstanding, relevant offers. All of these options, and others, can be set by the individual users 14-16.

FIGS. 8-19 show one environment where public stream system 12 can be employed. In the embodiment of FIGS. 8-19, public stream generation and distribution system 24 is implemented as a public search system 220. FIG. 8 is a simplified block diagram of one embodiment of a social network that includes public stream system 12 with public search system 220. Public search system 220 illustratively includes topic feed generator 22, feed distributor component 224, and search component 226. Public search system 12 is also shown connected to a topic and statistics data store 228. In the embodiment shown in FIG. 8, public search system 12 is also illustratively connected to user interface component 230 which resides on a client device. The client device can be any suitable computing device, such as a laptop computer, a cellular telephone, smart phone, any other type of personal digital assistant (PDA), other handheld device, other mobile device, or other computing device (such as a desktop computer). System 220 (which embodies system 24 in FIGS. 1-7) and system 26 illustratively communicate with one another using processor 28 or otherwise to perform as described above with respect to FIGS. 1-7.

In the embodiment shown in FIG. 8, public search system 12 is shown connected to user interface component 230 through network 22. User interface component 230 can be part of components 52 and 54 or separate therefrom. Network 22 can be a local area network, a wide-area network (such as the Internet) or any other desired network. Of course, user interface component 230 could also be directly connected to, or reside on, public search system 12. FIG. 8 also shows that public search system 12 is connected to search engine 232 which, itself, is connected either through a network 234, or directly, to a corpus 236 that is to be searched.

It will be appreciated that the block diagram shown in FIG. 8 is exemplary only. The functions associated with the elements described can be combined into a single component, or further divided into more discrete components. Similarly, the connections shown in FIG. 8 can be through networks, or direct connections, and those shown are for exemplary purposes only.

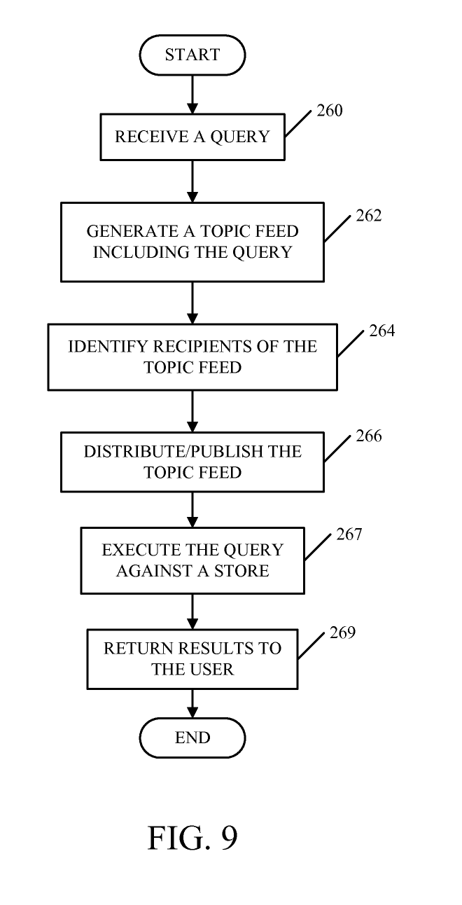

FIG. 9 is a simplified flow diagram illustrating one embodiment of the operation of social network shown in FIG. 8. FIGS. 10A-10C show illustrative user interface displays corresponding to the operation of the system described with respect to FIG. 9. FIGS. 8-10C will be described in conjunction with one another.

User interface component 230 illustratively resides on a user's system, which may be a client device. In one embodiment, in order to use system 12, a user first engages user interface component 230 to set up an account which includes, for example, a user name and password. The user inputs these items through interface component 230, and they are stored in topic and statistics data store 228. The user is illustratively able to identify topics of interest which the user wishes to follow, or individual users or groups of users that the user wishes to follow as well. This can all be done through user interface displays generated by component 230.

Once this is done, and the user wishes to use system 12, the user illustratively logs on to system 12, through an authentication component (which is described in greater detail below), and user interface component 230 generates a user interface display 238 such as that shown in FIG. 10A. In the illustrative user interface display 238, the user's user name is John Doe and that is displayed generally at 240, along with an image 242 which can be selected by John Doe to represent his user name. The display also presents a search box 244, which is a text box that allows the user to enter text (such as by using a keyboard) that represents a search query that the user wishes to have executed. Interface display 238 also illustratively displays the user names or topics that user 240 is following. This is generally indicated at 246. User interface display 238 may also illustratively list other users that are following user 240. This is generally indicated at 248. In addition, user interface display 238 displays a public stream of information 32, which has already been generated. The public stream 32 illustratively includes a plurality of posts 250, corresponding to received topic feeds 252 which will be described in greater detail below. Further, user interface display 238 illustratively includes a set of actuable elements generally shown at 256. By actuable (or actuatable) elements, it is meant that the elements can be actuated through a suitable user interface operation, such as by clicking on an element using a pointing device (like a mouse) or double-clicking or otherwise. These are described in greater detail below as well.

When the interface display 238 is displayed by user interface component 230, the user can enter a desired query into textbox 244. In the example shown in FIG. 10A, the user has typed in “Where can I buy skis?”. This corresponds to query 258 shown in FIG. 8. The query is sent from user interface component 230 to public search system 220, and specifically to topic feed generator 222. Receipt of query 258 by public search system 220 is illustrated by block 260 in FIG. 9.

Topic feed generator 222, in response to receiving query 258, generates a topic feed that includes query 258 and that is to be output in the public stream 32 as a topic feed 252. Generating the topic feed 252, including the query 258, is indicated by block 262 in FIG. 9.

Feed distributor component 224 then accesses data store 228 to identify the followers of both John Doe (the user that submitted query 258) and the followers of the subject matter content of the query 258, itself. For instance, the subject matter content of query 258 is illustratively “skis or skiing”. Therefore, if any users have indicated that they wish to follow the topic category (or subject matter category) “skis or skiing”, then they would be identified by feed distributor component 224 as a recipient of topic feed 252 as well. Feed distributor component 224 then distributes or publishes the topic feed 252 to those recipients that were identified. Identifying recipients is indicated by block 264 in FIG. 9, and distributing the topic feed 252 to the recipients is indicated by block 266 in FIG. 9. It can thus be seen that upon submission of query 258, system 12 automatically publishes that query in a topic feed to all relevant recipients, without any further input from the user.

The distribution or publication can be done in other ways as well. For instance, feed distribution component 224 can wait to update the system of a recipient until the recipient logs on to the system or otherwise engages the system. Similarly, the feed distribution component 224 can wait to distribute topic feed 252 to recipients until after the user has interacted with the results from the query (as described below).

It should be noted that, in FIG. 10A, a wide variety of other embodiments can be used. For instance, public stream 32 may be divided into two streams, one which reflects posts from people that the user is following and the other that reflects posts from topic areas that the user is following. Of course, a wide variety of other changes can be made to the display shown in FIG. 10A, as well.

Once the topic feed 252 has been distributed and published to the identified recipients, a user interface component 230 (corresponding to the recipients) illustratively generates a display for those recipients, such as shown in FIG. 10B. FIG. 10B is similar to that shown in FIG. 10A, except that the user 240 is indicated as Jane Deer. It can be seen from FIG. 10A that Jane Deer is one of the followers of John Doe. Therefore, the topic feed 252 generated from any activity of John Doe will be distributed to, and published at, a user interface component 230 residing at Jane Deer's device.

The topic feed 252 is posted as a post 250 on the public stream 32 of the user interface display shown in FIG. 10B. It can be seen in FIG. 10B that the public stream 32 includes the post “John Doe searched for stories about Where can I buy skis?”. FIG. 10B shows that both the source of the post and the search which is the subject matter of the post are actuable links, and this is indicated by boxes 266 and 268 in FIG. 10B. Therefore, the term “John Doe” is included in box 266 and the query “Where can I buy skis?” is included in box 92. If the user of the system that generated the display in FIG. 10B (that is, Jane Deer) clicks on the text in either box 266 or 268, then the user's system takes action. If the user clicks on box 266, which contains the source of the post, then the user's system links the user to the home page of the person identified in box 266 (John Doe). Therefore, if Jane Deer clicks on box 266 that includes “John Doe”, then Jane Deer's system navigates to the home page for John Doe, and presents Jane Deer with a user interface display such as that shown in FIG. 10A. If Jane Deer clicks on box 268, the results for that query will be returned to Jane Deer. This will be described in more detail below.

At the same time that feed distributor component 224 is distributing the topic feed generated by generator 222, search component 226 is also providing query 258 to search engine 232 for execution against corpus 236. Search engine 232 may illustratively be a conventional information retrieval search engine that searches the web for content associated with the query that was input. Search engine 232 can alternatively be implemented in search component 226. Search engine 232 executes the search against corpus 236 and returns search results 259 to search component 226 in public search system 12. Search component 226 then returns results 259 to user interface component 230 corresponding to the author of the query 258 (that is, corresponding to John Doe). This is indicated by blocks 267 and 269 in FIG. 9.

Not only does search component 226 pass query 258 on to search engine 232 for execution against corpus 236, but search component 226 also searches the records stored in data store 228 for any other posts that are relevant to the subject matter of query 258. It may be that John Doe or other users of public search system 12 have submitted similar queries, and therefore topic feeds 252 may have already been generated for those similar queries. Thus, search component 226 searches data store 228 for posts from previously generated topic feeds 252 that are relevant to query 258. These are returned to the user through user interface component 230 as stream results 261. In other embodiments, the records returned from searching data store 228 can be used to re-order search results 259 returned from search engine 232 or a search engine other than search engine 232.

User interface component 230 then generates a display 270 for the user (who submitted the query) such as that shown in FIG. 10C. The display shown in FIG. 10C is similar to that shown in FIG. 10A, and similar items are similarly numbered. However, there are a number of differences. It can be seen that FIG. 10C shows that the search results are presented in two separate categories. The first is stream results section 272 and the second is web results section 274. Under web results section 274, the search results 259 generated by search engine 232 are presented to the user as user actuable links. By way of example, one of results 259 is a URL entitled “ABC Ski Company has skis on sale”. It is shown in a box 276 to indicate that it is actuable on display 270. That is, if the user clicks on one of the results 259, the user will be taken to the web page, or other corpus entry, that spawned that search result. In addition, the user can be shown offers for skis by ABC Ski Company that are already stored in store 50 (FIG. 2).

Under stream results section 272, user interface display 270 lists all posts which contain search results 259 relevant to query 258. That is, if data store 228 included posts that were relevant to the query 258, those posts are also displayed in the stream results 272, along with the web results 274. Again, to the extent that there are any actuable links in stream results 261, posted in stream results section 272, the user can simply click on those actuable links and be taken to the underlying source that spawned the link.

FIG. 10C also shows that system 12 can suggest additional search strategies. This is shown generally at 276.

It can be seen that with public search system 220, offers can be communicated to, and interacted with by, users 14-16 as discussed above with respect to FIGS. 1-7. Groups can be identified as well.

### Sharing Activity

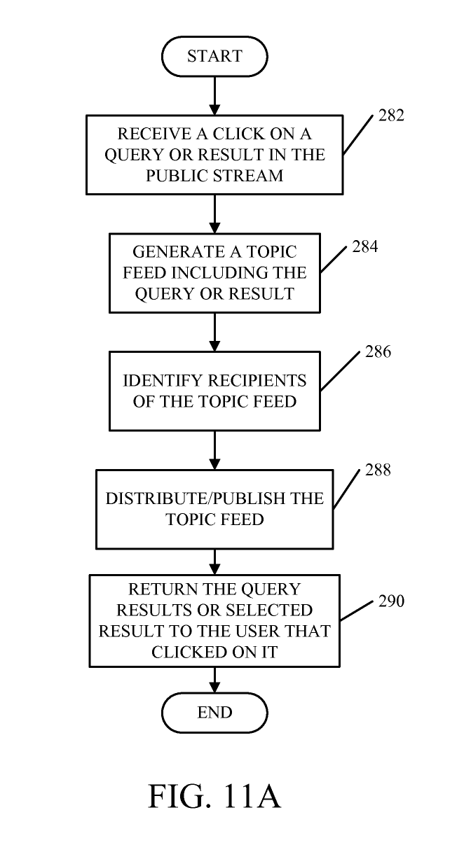

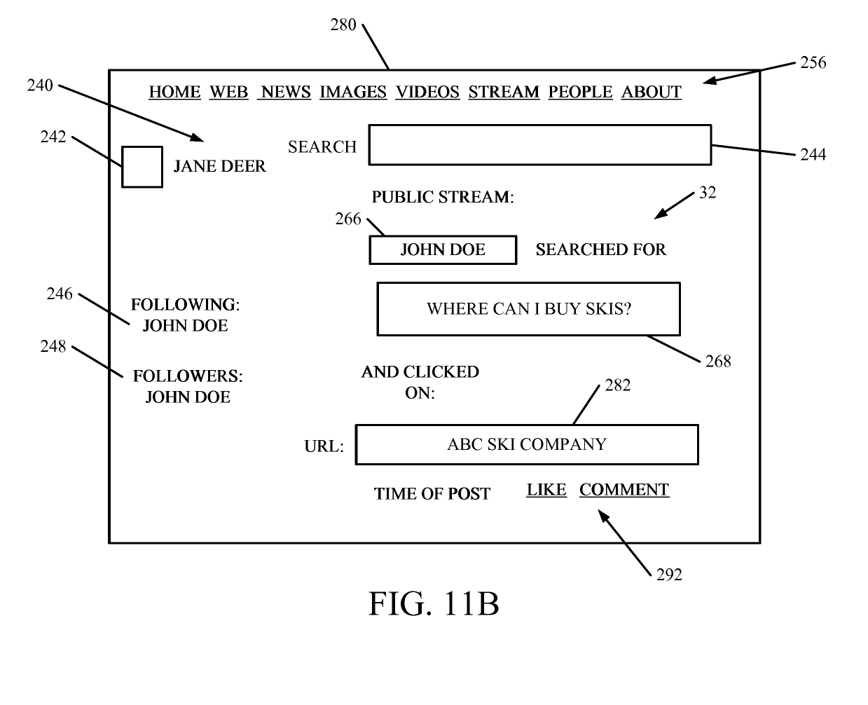

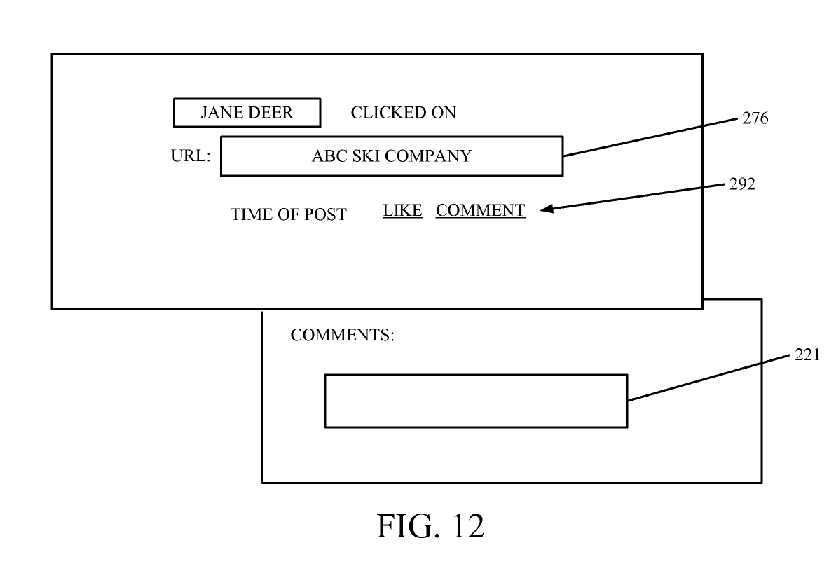

FIGS. 11A-12 illustrate yet another embodiment. In the embodiment shown in FIGS. 11A-12, not only is the public stream 32 filled with topic feeds 252 that contain queries, but it also contains other search activities by users, such as whether the user clicked on one of the results 259 returned in response to a query 258, or whether the user actuated any of the links in the public stream 32. FIG. 11A is a flow diagram illustrating one embodiment of the operation of the system shown in FIG. 8, where a user (e.g., Jane Deer) that has received topic feed 252 actuates one of the links in one of the posts in topic feed 252.

By way of example, assume that John Doe had clicked on one of the search results, such as result 276, that was presented in response to the query 258. In that case, the user interface display 280 generated at Jane Deer's device is updated to look like that shown in FIG. 11B. That is, it would not only show that John Doe had searched for buying skis, but it would also indicate that John Doe clicked on (or actuated a link for) one of the search results 276. In the embodiment shown in FIG. 11B, display 280 also shows that the public stream 32 has been updated to indicate that John Doe clicked on the particular URL “ABC Ski Company” that is highlighted by box 282 to indicate that it is also actuable by Jane Deer.

One embodiment of the operation of system 12 in generating this type of post is shown in FIG. 11A. First, FIG. 11A shows that public search system 220 receives either a click on a query or a result that was previously displayed in public stream 32 by user interface component 230. That is, assume that John Doe clicked either on a query in his public stream 32 or (in this case) one of the search results 276 displayed in FIG. 10C. This information is conveyed to public search system 12 as illustrated by block 150 in FIG. 11.

Topic feed generator 222 then generates a topic feed that includes either the query clicked on by John Doe, or, in this case, the result 276 from web results 259 that was clicked on by John Doe. Generating the topic feed, including the actuated result, is indicated by block 284 in FIG. 11A.

Feed distributor component 224 then identifies recipients of the topic feed just generated, and distributes or publishes the topic feed generated in block 284 to those recipients. This is indicated by blocks 286 and 288. Therefore, as shown in FIG. 11B, Jane Deer's user interface display 280 is updated with an additional post to the public stream 32 which shows that not only has John Doe 266 searched for “Where can I buy skis?”, but he actually clicked on one of the results 259 returned in response to that query, namely a URL entitled “ABC Ski Company” 276, shown in block 282 in user interface display 280.

In response to John Doe clicking on that result, search component 226 and search engine 232 are used to return the document or page that spawned the link in box 282, to John Doe over user interface component 230, for viewing. This is indicated by block 290 in FIG. 11A.

While FIG. 11A has been described with respect to John Doe clicking on one of the search results 259 that was returned in response to the query 258, the same action is taken if any other user clicked on an actuable link in their public stream 32. For instance, if Jane Deer is presented with the user interface display 280 shown in FIG. 11B, Jane Deer can then click on the query “Where can I buy skis?” 268 or on the result “ABC Ski Company” shown in box 282, and public search system 12 will generate a topic feed 252 for that activity as well. That is, assuming that Jane Deer has clicked on the query in box 268, topic feed generator 222 will generate a topic feed that includes that query, and feed distributor component 224 will distribute the topic feed to all identified recipients for that topic feed. Similarly, search component 226 and search engine 232 will return the results 259 of the actuated query to the user interface component 230 used by Jane Deer and that will be displayed to John Doe, in a similar fashion to that shown in FIG. 10C (where they were displayed for John Doe) in the first instance.

Similarly, if Jane Deer were to instead click on the result in box 282, then John Doe's user interface display would be updated to show that as well. This is because John Doe is a follower of Jane Deer and would therefore be the recipient of any topic feeds generated by Jane Deer's search activity.

### Other Features

User interface displays 10A-10C and 11B show a number of additional features as well. First, the user interface displays include a number of navigation buttons generally indicated at 256. These buttons illustratively include a “home” button, a “web” button, a “news” button, an “images” button, a “videos” button, a “stream” button, a “people” button, and an “about” button. Of course, these are exemplary buttons only and different buttons, additional buttons, or fewer buttons could be used as well. In the embodiment shown, the “home” button takes the user to the user's home page showing the public stream 32 generated using topic feeds 252 that were received by that user. The “web” button takes the user to a web browser and the “news” button takes the user to a news site that displays news that may be relevant to the user. The “images” and “videos” buttons allow a user to easily confine submitted queries to look for either images or videos that are relevant to the search terms in the query, and the “stream” button allows the user to search the user's own public stream 32 for posts relevant to the query. The “people” button allows the user to identify people of interest, that the user may wish to follow. The system can also automatically suggest experts and other people to follow even if the user does not actuate the “people” button. The “about” button describes the functionality of the system.

A number of the user interface displays also include additional features on the bottom of the posts, generally indicated by arrow 292. They include a “time of post” feature, a “like” feature and a “comment” feature. The “time of post” feature simply indicates the time that a post was posted on the user's public stream 32. The “like” button allows the user to indicate that he or she likes the post, and the “comment” button allows the user to comment on the post. This may be done, for instance, by exposing a text box within which the user can comment on the post and have that comment published to other recipients. One embodiment of this is shown in FIG. 12. FIG. 12 shows part of a post that includes the result 276 discussed above. FIG. 12 also shows that, once the user has actuated the “comment” button, a dropdown text box 221 appears, which allows the user to enter a textual comment related to the post 103. The textual comment in box 221 is then distributed to identified recipients.

### More Detailed Embodiment

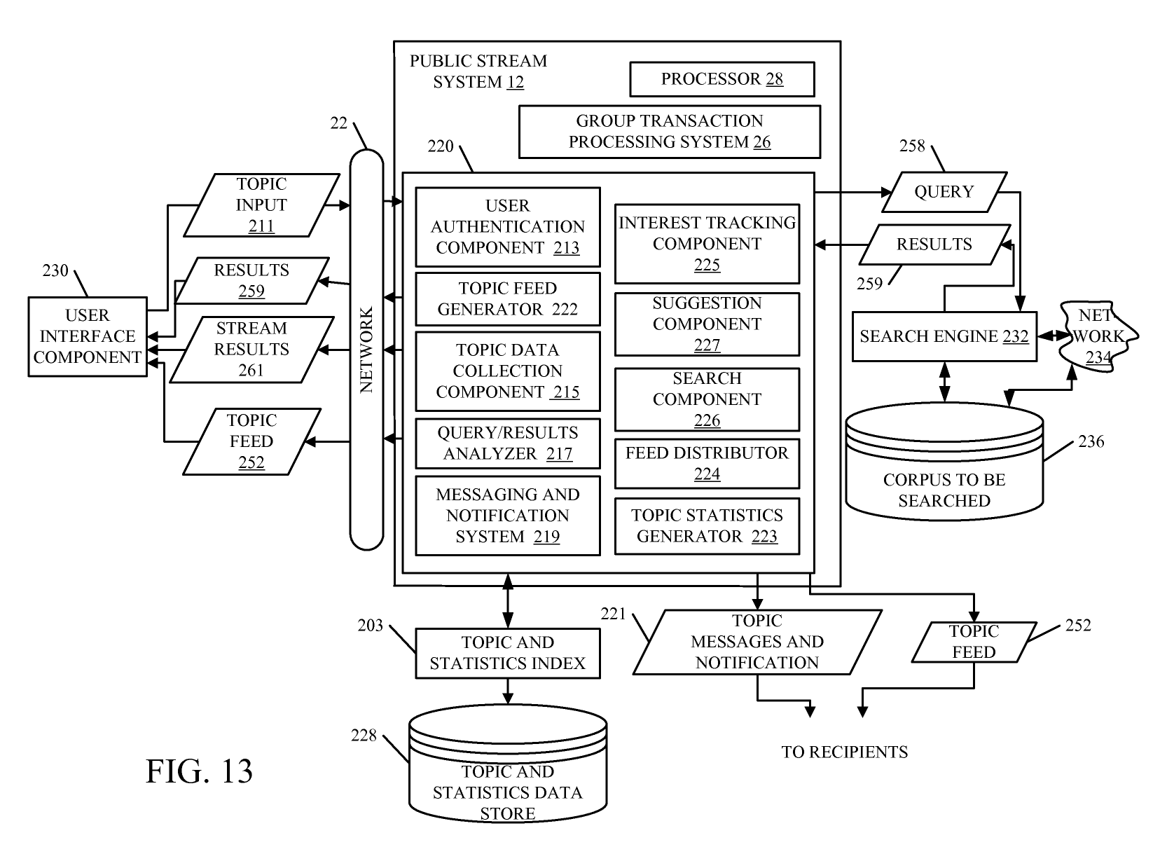

FIG. 13 illustrates a more detailed block diagram of system 12, and particularly a more detailed block diagram of one embodiment of public search system 220. Items in FIG. 13 which are similar to those shown in FIG. 8 are similarly numbered. However, FIG. 13 shows that public search system 12 includes a variety of other components as well.

The input from user interface component 230 to public search system 12 is shown not simply as query 258, but as a topic input 211. Topic input 211 can be a query, a click, an administrative input, such as the input of a user name or password to log on to the system, an explicit indication of a topic or person of interest that is to be followed, or a wide variety of other inputs.

Public search system 12 also includes additional components such as user authentication component 213 which is used to authenticate user's logging on to the system. Public search system 12 also includes topic data collection component 215 which collects various items of data (described below) that are stored in data store 228. System 12 also includes query/result analyzer 217 that can be used to both identify the subject matter content of queries and results, and to analyze whether they should more properly be pursued in a private venue. This can also be used to identify subject matter of a transaction or offer, as described above with respect to FIGS. 1-7.

Messaging and notification system 219, also included in system 12, is used for receiving and transmitting messages among users of system 12, and also for providing notifications to users in system 12. The messages and notifications are indicated by block 221.

System 12 also includes topic statistics generator 223 that generates a variety of statistics which will be described below, as well as interest tracking component 225 and suggestion component 227. Interest tracking component 225 processes the various queries and search results that a user interacts with on system 12 to implicitly determine a user's interests. These are included, along with interests explicitly input by a user, to not only suggest topics or people to follow, but to also suggest changes to search queries that might be input by a user. These suggestions are generated by suggestion component 227. In addition, these interests can be used to identify groups of users to receive offers, as described above with respect to FIGS. 1-7.

FIG. 13 also shows that data store 228 has its own index 203. Index 203 indexes the information in data store 228 for ease of searching.

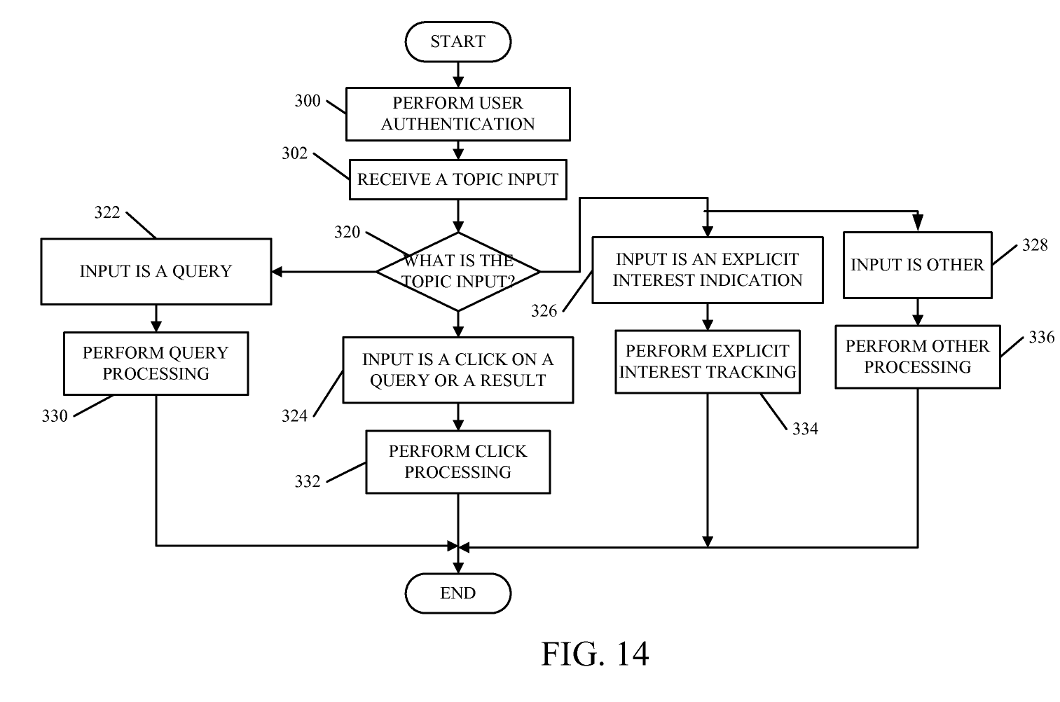

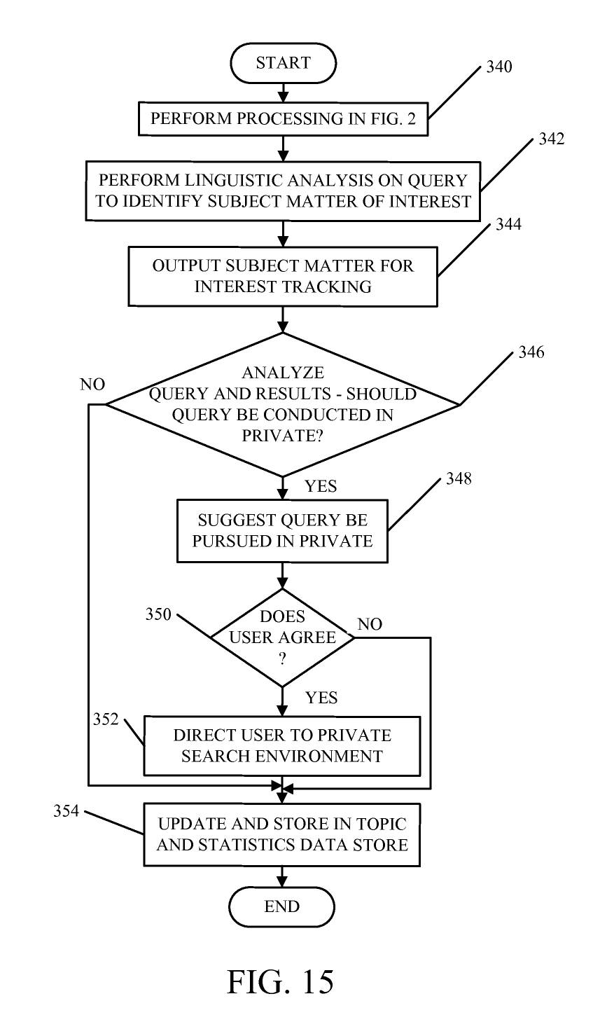

FIG. 14 is a flow diagram illustrating one embodiment of the operation of the system shown in FIG. 13. FIGS. 13 and 14 will be described in conjunction with one another. It should be noted, of course, that the features described in FIGS. 13 and 14 can be in addition to, or instead of, those shown in the previous figures. Also, the particular flow of operation described with respect to FIGS. 13 and 14 is illustrative only. In other words, certain steps could be reversed or performed in different orders or eliminated or other steps can be added. Similarly, the functions of the various components shown in FIG. 13 could either be combined or split even more finely, using other components. Those shown are shown for exemplary purposes only.

During operation, a user first logs on to system 12, through user interface component 230, by illustratively performing some type of user authentication steps. This is managed by user authentication component 213 and indicated by block 300 in FIG. 14. In one embodiment, user authentication simply requires the user to input a user name and associated password. User authentication component 213 then compares the user name and password with profile records stored in data store 228 (or another data store) to determine that the user is entering a valid user name and password. If so, processing continues. If not, the user is prohibited from accessing system 12, until a valid user name and password have been entered. Of course, other authentication components could be used, such as any type of biometric recognition system, voice recognition, etc.

Once user authentication has been performed, the user can provide a topic input 211 to public search system 12. The topic input can be a query, a click on a query, a comment, a click on a query result or a person, an indication that the user likes a particular post, an explicit indication that the user is interested in a given topic or a person, etc. Any type of input which reflects this type of search activity is received by processor 28 and routed to the appropriate components for analysis and processing. Receiving the topic input is indicated by block 302 in FIG. 14.

FIG. 14 shows that there are a number of different possibilities for the topic input 211. For instance, the topic input may be a query, or it may be a click (either on another person's query in a user's public stream, or on a search result that shows up in the user's public stream), it may be an explicit interest indication by the user indicating that the user is specifically interested in a topic area (such as a person or a subject matter area), or it could be another input. This is indicated by blocks 320, 322, 324, 326 and 328 in FIG. 14.

### Processing a Query

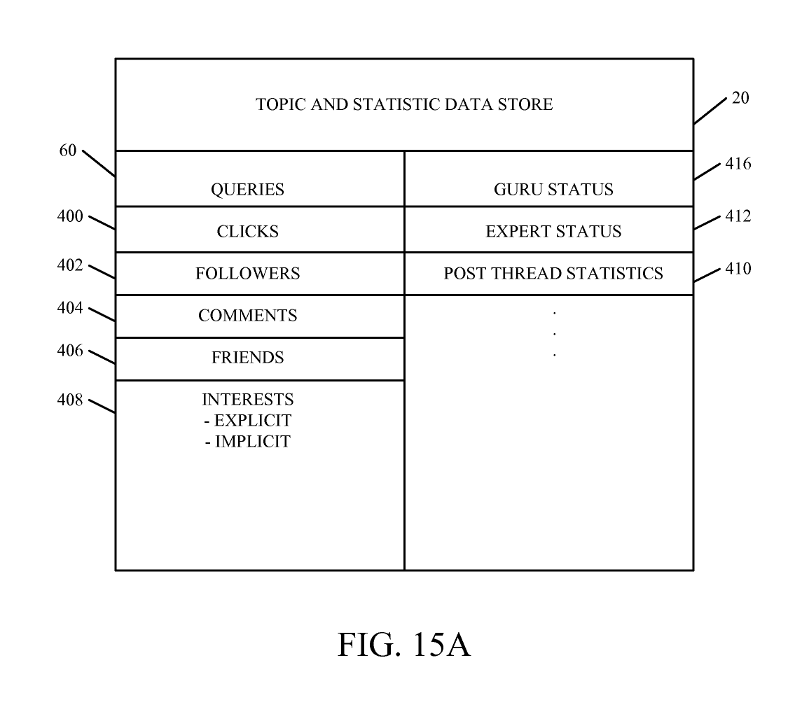

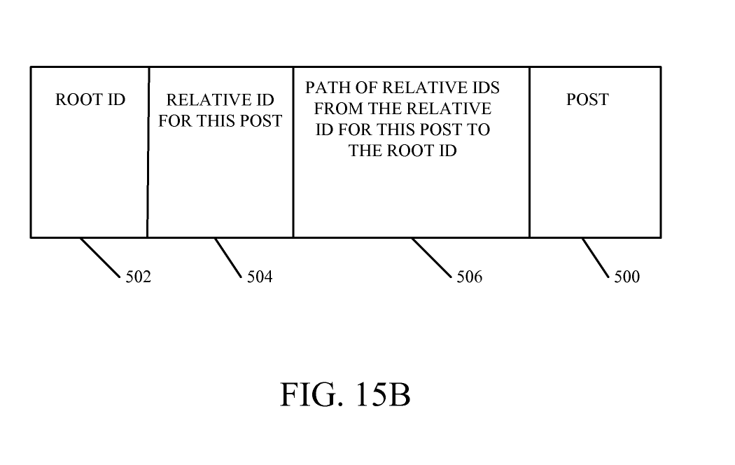

If, at blocks 320 and 322, it is determined that the input is a query, then query processing is performed as shown in FIG. 15. This is indicated by block 330 in FIG. 14.

If the input is a query, such as query 258, then the processing described above with respect to FIG. 9 is performed. This is indicated by block 340 in FIG. 15. That is, a topic feed 252 is generated for the query 258 and recipients of the topic feed are identified and the topic feed 252 is automatically distributed to those recipients. The query 258 is then executed against a data store 236 and against posts in data store 228 and the results are returned to the user. Embodiments of the user interfaces generated to show this were also described above with respect to FIGS. 10A-12.

However, FIG. 15 shows that, in another embodiment, additional processing can be performed as well. For instance, the query 258 can be provided to query/results analyzer 217 where a linguistic analysis is performed on the query 258 to identify the topics of interest reflected in the query. In one embodiment, keyword recognition is performed on the query to identify keywords, that are associated with topics of interest, that occur in the query. Of course, more advanced natural language processing and statistical analysis can be performed as well, to identify topics of interest. Performing linguistic analysis on the query is indicated by block 342 in FIG. 15.

The topics of interest identified in the linguistic analysis are then output to interest tracking component 225 (shown in FIG. 13). Interest tracking component 225 is described in greater detail below, with respect to FIGS. 17 and 18. Suffice it to say, for now, that interest tracking component 225 receives various items of information based on a user's activity (such as topics of interest reflected in queries or search results that the user has interacted with) and identifies areas of interest for the user based on all the information that the user is generating, or interacting with. This information is then used by group transaction processing system 26 to generate group offers as described above with respect to FIGS. 1-7. Outputting the results of the linguistic analysis to the interest tracking component 225 is indicated by block 344 in FIG. 15.

FIG. 15 also shows that query/result analyzer 217 can perform additional processing as well. For instance, when using public search system 12, a user may forget that the user's queries are actually being published. Therefore, in one embodiment, query/results analyzer 217 analyzes the query, and possibly the query results, to determine whether the query might more appropriately be conducted in private. For instance, the user may not wish the public to know that he or she is looking for a new job. If the user posts a query such as “where can I automatically update my resume?”, this may give the user's co-workers, and even supervisors, information that the user does not yet wish to be made public. Of course, there are a variety of other subject matter areas that a user may wish to search, but which the user does not wish to be made public. Therefore, query/results analyzer 217 is illustratively set up to analyze the text of a query, and the text of results, to determine whether they are related to subject matter areas that may best be kept private. This is indicated by block 346 in FIG. 15. If not, then processing simply continues at block 354, which is discussed below.

However, if, at block 346, query/results analyzer 217 determines that the query or results relate to a subject matter area that the user may wish to be kept private, then query/results analyzer 217 provides an output to user interface component 230 that suggests to the user that the query be pursued privately. This can take the form of a cautionary message that is in bold letters, in colored letters, or otherwise. The output may also allow the user to simply click “yes” or “no” to direct the system to a private search forum. Suggesting that the query be pursued privately is indicated by block 348 in FIG. 15.

If the user does not desire that the query be pursued privately, then processing again simply reverts to block 354. However, if, at block 348, it is determined that the user does wish to have the query pursued privately, then processor 28 simply redirects the user to a private search environment, such as by opening a web browser using a private search engine. Determining whether a user wishes to proceed privately and, if so, directing the user to a private search environment, is indicated by blocks 350 and 352 in FIG. 15.

At block 354, data collection component 215 and topic statistics generator 225 collect various items of information from the query (and optionally the results) and generate desired statistics from that information and update and store the topic and statistics data generated, in data store 228. The information is illustratively indexed and the index entries are stored in index 203 as well.

### Processing Clicks

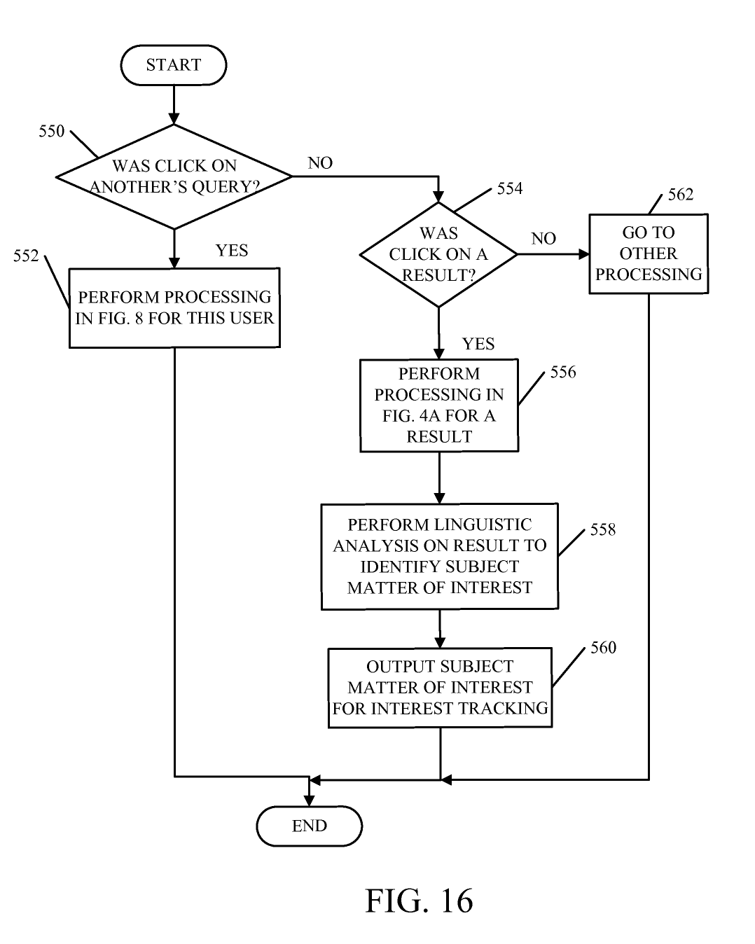

Referring again to FIG. 14, if it is determined at block 324 that the topic input 211 is not a query, but is instead a click on a query or a click on a result, then click processing is performed, as indicated at block 332. One embodiment of click processing is described, in more detail, in FIG. 16.

Processor 28 first determines whether the click received as topic input 211 was on another user's query. This is indicated by block 550 in FIG. 16. If the input was a click on another user's query, then system 12 performs query processing as shown in FIG. 15, except that it is performed for the present user (who just clicked on the query) instead of for the user that previously input the query. For instance, if John Doe generates the query “Where can I buy skis?” and this is posted to the public stream 32 of Jane Deer, and Jane Deer clicks on that query, then query processing is performed in the same way as if Jane Deer had input the query originally, except that topic data collection component 215 and topic statistics generator 223 generate information and statistics for Jane Deer that show that she clicked on someone else's query, instead of input it herself. Analyzing the text of the query and returning results, etc., is performed in the same way as shown in FIG. 15. This is indicated by block 552 in FIG. 16.

If, at block 550, it is determined that the click was not on another's query, then processor 28 determines whether the click was on a search result input by another. This is indicated by block 554 in FIG. 16. If so, then system 12 performs the same processing as shown in FIG. 11A, for a click on a result. This is indicated by block 556 in FIG. 16.

FIG. 16 also shows that system 12 can illustratively perform additional processing, based on clicks, as well. It is not only queries input by users that indicate the interests of the users, but the results that the user interacts with (e.g., clicks on) also indicate the interests of a given user. Therefore, query/results analyzer 217 can perform linguistic analysis on the text of a result that was clicked on to identify the subject matter corresponding to that result. This is indicated by block 558. Those subject matter areas are output to interest tracking component 225 to assist in tracking the interests of the present user. This is indicated by block 560 in FIG. 16. The operation of interest tracking component 225 is discussed in greater detail below with respect to FIGS. 17 and 18.

If, at block 554, it is determined that the click was on some other portion of the user interface display, then processing proceeds with respect to block 328 in FIG. 14. This is indicated by block 562 in FIG. 16.

### Processing Other Inputs

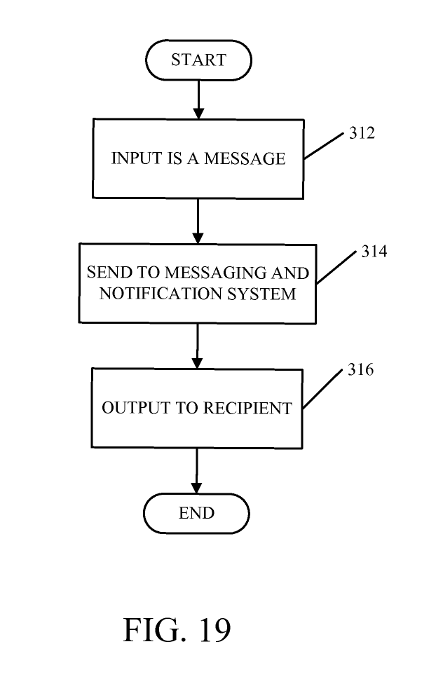

Referring again to FIG. 14, if, at block 320, it is determined that the input 211 is some other type of input, the appropriate action is simply taken, as indicated by block 336 in FIG. 14. For instance, FIG. 19 shows a flow diagram illustrating the operation of system 12 when the input 211 is a message. In that case, the message is sent to messaging and notification system 219 and output to the desired recipient. This is indicated by blocks 312, 314 and 316.

Appropriate processing is performed for any other input 211 as well. For instance, if the user clicks on the “comment” button and inputs a textual comment, then processor 28 controls system 17 to receive the textual input, as the comment, through user interface component 230 and identify recipients that are to receive it and then distribute it to those recipients.

It should also be noted that system 12 can include other things as well. For instance, though the description has proceeded with respect to system 12 receiving mouse clicks, textual inputs, etc., other input and output modes could also be used. User interface component 230 can receive speech input from the user and perform speech recognition, and system 12 can be controlled in that way as well. Alternatively, the speech recognition can be performed in public search system 12. Similarly, user interface component 230 can include text synthesis components that synthesize text into speech and communicate audibly with the user. A wide variety of other changes can also be made to the system.

### Data Store 228

FIG. 15A illustrates one embodiment of a number of different items of information that can be stored in topic and statistics data store 228. Of course, the items of information shown in FIG. 15A are all related to an individual user. Therefore, it can be seen that data store 228 illustratively stores all of the queries 258 input by a given user, the clicks on other person's queries and clicks on search results as indicated by 400 in FIG. 15A, all of a user's followers 402, all of the comments 404 posted by the user, any friends 406 of the user (if friends are separately designated from followers) the user's interests, both explicitly indicated by the user, and implicitly derived by interest tracking component 225, as indicated by block 408 in FIG. 15A, post thread statistics associated with posts that were generated by the user, and the user's status. This is indicated by block 410 in FIG. 15A. Data store 228 also indicates a user's status as an expert or a guru as indicated by blocks 412 and 416 in FIG. 15A. Data store 228 is shown for exemplary purposes only and other types of data can be stored as well.

### Post Thread Statistics

Topic statistics generator 223 illustratively generates post thread statistics which indicate the number of times that the user's posts have been interacted with (such as clicked on or re-posted) by others. For instance, if John Doe submits a query 258 which is posted to the public stream 32 of his followers, and one of the followers (such as Jane Deer) clicks on the query 258, then the query will also be posted on the public stream 32 of all of the followers of Jane Deer. Thread statistics 410, which are generated by topic statistics generator 223, track how many times the user's posts have been posted and re-posted in system 12.

In order to do this, each of the queries (or posts) is stored in data store 228, in one exemplary embodiment, according to a data structure such as that shown in FIG. 15B. It can be seen that the post itself, 500, has an associated root identifier (ID) 502, a relative identifier (ID) 504, and a path of relative identifiers (IDs) 506. The root ID 502 for the post is a unique identifier associated with the author, or originator, of the post. In the example being discussed, the root ID 502 is that associated with John Doe.

The relative ID for this post 504 is associated with someone downstream of John Doe who re-posted John Doe's original post. In the example being discussed, the relative ID 504 corresponds to Jane Deer. The path of relative IDs 506 extends from the relative ID (the most recent poster) for this post to the root ID 502. For instance, assume that Jane Deer's relative ID is 14. Then the path of relative ID's 506 is 14, 1. If one of Jane Deer's followers then re-posts the query, the root ID for the re-posted query stays the same (1), the relative ID belongs to the follower of Jane Deer (say the relative ID for that follower is 28) and the path of relative ID's is 28, 14, 1. In this way, statistics generator 225 not only keeps track of who originated the posts, but it keeps track of the number of times the post has been re-posted. It also keeps track of the path of followers through which the post traveled.

These types of post thread statistics are of interest for a number of reasons. For instance, on some social networking sites, when a post of an individual is widely disseminated, it is referred to as “going viral.” There can be some prestige associated with a post that has gone viral. However, it can be difficult to identify the originator of the post. Therefore, using statistics generator 223 and the data structure shown in FIG. 15B (or some similar data structure) system 12 can easily track the originator of viral posts, and give the originator credit for the post threads. Similarly, when a user generates an offer to post it, the incentives to the user can more easily be tracked and awarded this way. That is, the originator, and not an intermediate poster, will be awarded appropriate incentive.

### Expert and Guru Status

Expert status 412 and guru status 416 are illustratively assigned to users that have displayed a great deal of knowledge, or are widely followed, in a given topic area. These users are trusted resources in their given topic areas. For instance, if John Doe has displayed a great deal of knowledge, or is widely followed and, in fact, has a sufficient number of followers, in the topic and area of skis, then John Doe may be awarded the expert status 412 in the topic area of skis. If John Doe happens to be the most knowledgeable, or the most followed user in that subject matter area, then John Doe is illustratively awarded the highest (e.g., guru) status 416. This is indicated in data store 238 as well.

Group transaction processing system 26 can make use of this as well. For instance, it may be more valuable to vendors 18-20 to have an expert or guru generate an offer in the relevant subject matter area. Because this information is known, the vendor can offer increased incentives to experts or gurus that initiate relevant offers.

In any case, data collection component 215 and topic statistics generator 223 can illustratively collect or generate the information necessary to award any desired status (for a topic or subject matter area) to one or more users, based on popularity, or other statistics.

### Interest Tracking

To discuss interest tracking reference is again made to FIG. 14. Recall that a user can provide an input that explicitly identifies that the user is interested in something or someone. This is referred to as an explicit interest indication. If, at block 320, it is determined that the input 211 is an explicit interest indication (shown at block 326) then explicit interest tracking is performed as indicated by block 334. FIG. 17 shows a simplified block diagram of one embodiment of interest tracking component 225, and FIG. 18 shows one embodiment of its operation. FIG. 17 shows that interest tracking component 225 includes an implicit interest tracking component 580 and an explicit interest tracking component 582. Explicit interest tracking is discussed below, while the operation of implicit tracking component 580 is described first.

As briefly discussed above with respect to FIG. 13, interest tracking component 225 receives a variety of information and operates on that information to implicitly identify interests of a given user. By implicitly identifying interests, it is meant that the user has not made an explicit interest indication indicating that the user is interested in a certain subject matter area or person but instead component 518 implicitly derives that information based on analysis of a user's activity.

For instance, a user may explicitly indicate that he or she is interested in a topic by providing an appropriate input through user interface component 230. However, implicit interest tracking component 580 takes other inputs by the user and analyzes them to implicitly define the interests of the user. The information shown in FIG. 17, that is considered by component 518, is exemplary only, and other or different information can be used as well. However, the exemplary information shown in FIG. 17 includes textual information from queries 584, textual information derived from posts that the user has clicked on 586, and textual information from subject matter that the user has “liked” or indicated a preference for 588. The textual information from queries 584 can be the results of a grammatical analysis performed on the queries posted by the user, and may include (by way of example) keywords or predefined topics or people of interest to which the queries relate. Similarly, the information from clicks 586 can be grammatical information derived from queries that have been clicked on by the user, or results that have been clicked on by the user. In addition, the information from likes 588 can be generated from posts which the user has “liked” as discussed above with respect to FIGS. 10A-12. Alternatively, of course, tracking component 225 can receive the raw text from those sources and submit it to query/results analyzer 217 (or another component) for grammatical analysis as well. This is indicated by optional block 602 in FIG. 18.

Once implicit interest tracking component 580 receives grammatically analyzed text (as indicated by blocks 600 and 602 in FIG. 18), it, or another component, illustratively performs statistical analysis on content words of that text to identify implicit topics of interest. This is indicated by block 604. For instance, if implicit interest tracking component 580 simply receives a set of keywords that have been grammatically extracted from the textual sources, then implicit interest tracking component 580 illustratively counts and stores the frequency of occurrence of those words in the textual inputs. By identifying the content words that are most searched, or otherwise used or interacted with by a given user, implicit interest tracking component 580 can map those words to topics of interest that are recognized in system 12, or it can generate new topics of interest. For instance, if keywords that correspond to a particular subject matter (such as the words “skis and poles”) are frequently used in queries, implicit component 518 can identify “skis and ski equipment” as a particular subject matter area of interest for the user. In addition, if the analyzed text includes the name of another user (with sufficient frequency) then that user may be identified as an interest of the current user. Similarly because data store 232 stores data that identifies other users that have similar interests to the present user, interest tracking component 225 can implicitly identify those other users as possible people for the current user to “follow”. Further, because system 12 identifies experts and/or gurus associated with topics of interest, system 12 can suggest these experts and/or gurus to the user as well. Performing the statistical analysis on the content words and other users is indicated by block 604. The same type of analysis can be performed on topics of interest (as opposed to content words) if the topics of interest are provided instead of just the content words.

Interest tracking component 225 also includes explicit interest tracking component 582. In one illustrative embodiment, a user can input an explicit interest indication by marking certain textual items, explicitly, as being items of interest to the user. For instance, the user can use the # tag before, or after, or surrounding, textual words to explicitly indicate that the user is interested in topics that correspond to those words.

This can also be used to remove certain textual items from the implicit interest tracking analysis. For instance, if the user inputs a query which includes the term “White House”, the user may be referring to the president's residence in Washington DC, or to houses that are white in color, generally. If the text is not explicitly marked by the user, then implicit interest tracking component 580 may either analyze the text and believe that the user is interested in the president's residence, or in white houses in general. However, if the user explicitly marks the text as follows “#white# #house#” then the term “White House” will be removed from the implicit tracking analysis performed by component 580, and the terms “white” and “house” will be input as specifically, and explicitly, marked interests 584 to explicit component 582. Explicit component 582 can correlate the marked interest 584 to already defined topics of interest, or it can use that information to define a new topic of interest that the user can follow.

After it has received the textual inputs and performed the linguistic and statistical processing, interest tracking component 225 generates a list of the top N interests 585 which have been derived for the given user. The top N interests will, of course, include all of those interests which have been explicitly indicated by the user. However, they may also include a number of topics of interest that have been implicitly derived by component 580. The number, N, of topics of interest that are output and stored for a given user can be empirically set, or it can be chosen by the user, or it can simply be selected at random or any other way. For instance, in one embodiment, interest tracking component 225 keeps track of the top 50 topics of interest for a given user, whether they are implicitly derived or explicitly input.

Once all the inputs have been analyzed, interest tracking component 225 combines the implicit topics of interest with the explicit topics of interest, as indicated by block 606, and updates data store 232 to indicate the new or revised topics of interest, and also outputs them for review by the user. This illustratively includes a separate list of other users who are experts or gurus or simply share the same topics of interest. This is indicated by block 608. Interest tracking component 225 can do this in a number of different ways. For instance, interest tracking component 225 can automatically update the “Following” list on the user's home page to include any newly identified topics of interest (subject matter areas or people), and to delete old topics of interest, which no longer fall within the top N topics of interest 585 output by component 225. In this way, system 12 can automatically begin posting new posts to the public stream 32 of the user, to reflect the new, implicitly derived and explicitly indicated topics of interest. Of course, the user may not wish the system to automatically update his or her topics of interest in the “Following” list. Therefore, alternatively, interest tracking component 225 may simply provide an output that indicates to the user that certain changes in the user's topics of interest are suggested, and allow the user to accept or reject those changes, either individually, or as a group. This is indicated by block 610 in FIG. 18. Component 225 illustratively keeps updating the top N list 585 as the user uses system 12. In this way, the user can easily ensure that the public stream 32 contains posts that are of current interest to the user.

All interests (whether implicitly or explicitly derived) can be used by group transaction processing system 26. The information can be used to automatically identify members of a group, to allow a user to find members of a group, or to allow vendors to find members of a group. It can be used in other ways as well.

### Enterprise Search

It should be noted that while system 12 is described above as being completely public, it can also be public within a given context. For instance, system 12 can be deployed behind a firewall so only potential recipients that also reside behind the firewall will receive topic feed 252. This allows those in, for example, an organization to share search activity but keep that information behind the firewall. Thus, employees of a company can collaborate on generating offers and group transactions, and have frank discussions and conduct shared search activity about competitors without providing the competitors with access to sensitive information. System 12 can also be deployed on even a smaller scale, such as within a work group.

### Illustrative Computing Environment

FIG. 20 shows one illustrative computing environment where system 12 can be employed. The computing environment can be employed as public search system 12, user interface component 230, or both. Similarly, those components can be deployed on other type of computing devices, such as handheld devices, mobile devices, laptop devices, cellular telephones, smart phones, personal digital assistants (PDA), etc.

With reference to FIG. 20, an exemplary system for implementing some embodiments includes a general-purpose computing device in the form of a computer 810. Components of computer 810 may include, but are not limited to, a processing unit 820 (which can act as processor 28) a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically, but not always, includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media (which is not included in computer storage media) typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 13 illustrates operating system 834, application programs 835, other program modules 836, and program data 837.

The computer 810 may also include other removable/non-removable volatile/nonvolatile computer storage media. By way of example only, FIG. 18 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 20, provide storage of computer readable instructions, data structures, program modules and other data for the computer 810. In FIG. 20, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 can be operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 20 include a local area network (LAN) 871 and a wide area network (WAN) 873, but may also include other networks. Such networking environments are commonplace in offices, enterprise-wide computer networks, intranets and the Internet. Computer 810 can be used in many different applications. For instance, by way of example, and without limitation, it can be used for general purpose computing, data communication applications, in avionics, military applications or electronics, or shipping electronics. Of course, computer 810, or portions thereof, can be used in many other applications as well.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 20 illustrates remote application programs 885 as residing on remote computer 880. It will be appreciated that the network connections shown are exemplary and other means of establishing a communications link between the computers may be used.

Computer 810 may also act as one of the servers or server computers discussed with respect to FIG. 20. Also, it should be noted that many of the components shown in FIG. 20 can be fully implemented in silicon, or partially implemented in silicon. The particular configuration shown in FIG. 20 is exemplary only. The embodiments described above in FIGS. 1-19 can also be implemented by the processor and using memory and other components in FIG. 20.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of conducting a transaction for exchange of goods or services using a computer with a processor, comprising:
receiving an input, at the processor, from one of a plurality of users of a public stream system in which the processor is deployed, the public stream system receiving user inputs from the user and generating a post based on the user inputs and distributing the posts in a public stream to a plurality of other users;
analyzing the user input, with the processor, to identify that the user desires to conduct the transaction;
identifying, with the processor, a group of the user and the plurality of other users of the public stream system that may wish to participate in the transaction, based on a subject matter of the transaction;
identifying, with the processor, an offer available to the group;
informing members of the group of the transaction and the identified offer; and
tracking commitment to the offer by the members of the group, with the processor in the public stream system.

2. The computer-implemented method of claim 1 wherein tracking commitment comprises:
determining whether an incentive is due to any members of the group; and
if so, awarding the incentive.

3. The computer-implemented method of claim 1 wherein identifying a group, comprises:
analyzing the user input to identify the subject matter of the transaction;
comparing the subject matter of the transaction with topics of interest of the other users in the public stream system; and
if the subject matter of the transaction corresponds to a topic of interest for a given one of the other users, then identifying the given other user as a potential member of the group.

4. The computer-implemented method of claim 1 wherein identifying a group comprises:
generating a post, based on the user input, indicative of the user being interested in the transaction that the user desires to perform;
distributing the post in the public stream of the other users; and
identifying the other users that interact with the post in the public stream as potential members of the group.

5. The computer-implemented method of claim 4 wherein the user input comprises a search input and wherein generating a post distributed in the public stream of the other users comprises:
generating the post to include the search input and search results returned in response to the search input.

6. The computer-implemented method of claim 5 wherein identifying the other users that interact with the post comprises:
identifying the other users that click on the search input or the search results in the post;
identifying the other users that comment on, or indicate that they like, the post.

7. The computer-implemented method of claim 1 wherein identifying a group comprises:
analyzing the user input to identify the subject matter of the transaction;
identifying the other users that search, using the public stream system, for a product or service corresponding to the subject matter of the transaction as potential members of the group; and
identifying the other users that search, using the public stream system, for offers corresponding to the subject matter of the transaction as potential members of the group.

8. The computer-implemented method of claim 1 wherein identifying a group comprises:
generating an invitation to join the group based on the user input;
distributing the invitation to the other users in the public stream; and
identifying the other users that interact with the invitation, in the public stream, by accepting the invitation, as members of the group.

9. The computer-implemented method of claim 1 wherein identifying an offer comprises:
identifying the subject matter of the transaction based on the user input; and
searching a data store of pre-existing offers, from vendors, based on the subject matter of the transaction, to identify one or more relevant offers.

10. The computer-implemented method of claim 9 and further comprising:
displaying the relevant offers to the user for selection;
receiving user selection of one of the relevant offers; and
identified the selected one of the relevant offers as the identified offer.

11. The computer-implemented method of claim 1 wherein identifying an offer comprises:
generating a user interface display with user interface elements that receive inputs that set terms of an offer, to let the user define the offer as a user-defined offer;
receiving the inputs that define the offer to generate the user-defined offer;
sending the user-defined offer to one or more relevant vendors, through the public stream system; and
identifying the user-defined offer as the offer based on vendor interaction with the user-defined offer.

12. The computer-implemented method of claim 11 wherein sending the user-defined offer to one or more relevant vendors comprises:
generating a display, for the one or more relevant vendors, that has display elements that allow the one or more relevant vendors to accept the user-defined offer or propose a counter-offer; and
if the one or more relevant vendors propose a counter-offer, then sending the counter-offer to the user.

13. The computer-implemented method of claim 12 wherein sending the counter-offer to the user, comprises:
displaying a user interface display to the user with user interface elements that allow the user to accept the counter-offer or engage in further negotiations with the one or more relevant vendors.

14. The computer-implemented method of claim 1 wherein identifying an offer, comprises:
identifying one or more relevant vendors based on the subject matter of the transaction;
requesting an offer from the identified vendors, through the public stream system;
receiving at least one offer from the identified vendors; and
presenting the received offer to the user, through the public stream system, in a user interface display that allows the user to accept the received offer or propose a counter-offer.

15. The computer-implemented method of claim 14 wherein requesting an offer from the identified vendors, comprises:
generating a display for each of the identified vendors with interface elements that allow each of the identified vendors to specify terms of an offer and return the offer to the user through the public stream system.

16. The computer-implemented method of claim 14 wherein identifying one or more relevant vendors comprises:
identifying a subject matter of the transaction; and
comparing the subject matter of the transaction to subject matter corresponding to each of a plurality of different vendors; and
if the subject matter of the transaction corresponds to the subject matter for a given one of the vendors, then identifying the given vendor as a relevant vendor.

17. The computer-implemented method of claim 1 wherein identifying a group comprises:
storing statistics representing users of the public stream system that are interested in a transaction having a specific subject matter;
when the statistics indicate that a sufficient number of users are interested in the transaction with the specific subject matter, then identifying the users of the public stream system that are interested the transaction having the specific subject matter as a de-facto group.

18. A public search system, comprising:
a public stream generation and distribution system that receives user search inputs, provides search results based on the user search inputs, generates a post corresponding to each of the user search inputs and search results, and distributes the post in a public stream to users of the public search system;
a group transaction processing system that includes:
a transaction identifier that identifies that a given user desires to conduct a transaction based on a subject matter of a given user search input;
a group identifier component that identifies members of a potential group of the given user and other users, for participation in the transaction, based on the subject matter of the given user search input and based on topics of interest to the other users;
a transaction offer generator that generates a group offer that is sent to the members of the potential group through the public stream generation and distribution system and that provides user input elements that receive inputs from the members of the potential group indicating acceptance of the group offer; and
a transaction commitment tracking component tracking acceptance of the group offer by the members of the potential group and execution of the transaction by the members of the potential group; and
a computer processor that is a functional component of the public search system and that is activated by the group transaction processing system to facilitate identifying that the given user desires to conduct the transaction, identifying the members of the potential group and generating the group offer.

19. The public search system of claim 18 and further comprising:
a vendor identifying component that identifies relevant vendors for participation in the transaction, according to the group offer, based on the subject matter of the transaction and subject matter corresponding to the relevant vendors.

20. A computer storage medium storing instructions which, when executed by a computer, cause the computer to perform steps comprising:
receiving an input from one of a plurality of users of a public stream system the public stream system receiving user inputs from the user and generating a post based on the user inputs and distributing the post in a public stream to a plurality of other users;
analyzing the user input to identify that the user desires to conduct a financial transaction;
identifying a group of the user and the plurality of other users of the public stream system that may wish to participate in the transaction;
identifying a group offer available to the group;
informing members of the group of the transaction and the identified group offer; and
tracking commitment to the group offer by the members of the group.
